(19) United States
(12) Patent Application Publication
(10) Pub. No.: US 2008/0003496 A1
(43) Pub. Date: Jan. 3, 2008

(54) Electrochemical apparatus with barrier layer protected substrate

(76) Inventors: Bernd J. Neudecker, Littleton, CO (US); Jeanne M. McGraw, Golden, CO (US); Brian K. Emerson, Littleton, CO (US); Shawn W. Snyder, Golden, CO (US)

Correspondence Address: LAWRENCE SUNG0- S2IPLAW, PLLC, 401 9TH STREET, NW, SUITE 900-NIXON PEABODY LLP, WASHINGTON, DC, 20004-2128, US

(21) Appl. No.: 11/374,282

(22) Filed: Jun. 15, 2005

Related U.S. Application Data
(63) Continuation-in-part of application No. 10/215,190, filed on Aug. 9, 2002, now Pat. No. 6,916,679.

(51) Int. Cl. H01M 6/02; B05D 5/12; H01M 6/00

(52) U.S. Cl. 429/122; 427/58

(57) ABSTRACT

The present invention relates generally to fabricating well performing thin-film batteries onto metallic substrates, polymeric substrates, and doped and undoped silicon substrates. More specifically, the invention may include fabricating an appropriate diffusion barrier layer between the substrate and the battery part of the present invention that separates said two parts chemically during the entire battery fabrication process and the operation and storage conditions of the electrochemical apparatus during its entire lifetime. In one embodiment of the present invention, thin-film batteries fabricated onto a thin, flexible, stainless steel foil substrate using an appropriate diffusion layer show uncompromised electrochemical performance compared to thin-film batteries fabricated onto ceramic substrates when using a 700° C. post-deposition anneal process for the LiCoO₂ positive cathode.

### FIELD OF THE INVENTION

The present invention relates generally to the fabrication of lithium-based, solid-state, thin-film, secondary and primary batteries with improved capacity density, energy density, and power density. Flexible form factor and crystalline LiCoO₂, LiNiO₂, LiMn₂O₄ cathodes and/or derivative materials may be used.

### BACKGROUND OF THE INVENTION

The following passage describes the need and evolution of the present invention in view of the background technology in the field of thin film batteries.

Thin-film batteries may be fabricated by sequential vacuum depositions of the layered battery components onto a given substrate in, for example, the following order: positive cathode current collector, positive cathode, negative anode current collector, electrolyte (separator), negative anode, and encapsulation, where the latter may be a lamination process instead of a deposition process step (See, for example, B. Wang et al., Journal of the Electrochemical Society, Vol. 143 (1996) 3203-3213 or John B. Bates et al., U.S. Pat. No. 5,561,004). Optionally, the two terminals of a thin-film battery may not simply comprise extensions of the positive and the negative current collectors, but may be additionally deposited terminal contacts that make electrical contact to the respective current collector. For the best performing batteries, the positive cathode material may be insufficiently crystalline in the as-deposited state and, associated with this fact, may exhibit insufficient electrochemical properties (See, for example, B. Wang et al., Journal of the Electrochemical Society, Vol. 143 (1996) 3203-3213). For this reason, the positive cathode may be crystallized during battery fabrication, which can be achieved in a post-deposition, high-temperature (“anneal”) process (See, for example, B. Wang et al., Journal of the Electrochemical Society, Vol. 143 (1996) 3203-3213 or John B. Bates et al., “Thin-Film Lithium Batteries” in New Trends in Electrochemical Technology: Energy Storage Systems for Electronics, ed. by T. Osaka and M. Datta, Gordon and Breach, 2000). The anneal process, which is applied immediately after the deposition of the positive cathode, may limit the choice of materials for the substrate and positive cathode current collector, thereby limiting, in turn, the capacity density, energy density, and power density of the thin-film battery, both per volume and weight. The affect of the substrate on those three quantities is, for example, explained in more detail below.

The intrinsic (i.e., without substrate and without encapsulation) volumetric and gravimetric densities of the capacity, the energy, and the power of lithium-based, solid-state, thin-film secondary (rechargeable) and primary (non-rechargeable) batteries are dominated by the volumetric and gravimetric densities of the capacity, the energy, and the power of the positive cathode material. Crystalline LiCoO₂ may be an example of a preferred choice for the cathode material for both bulk (non thin-film) and thin-film batteries in terms of volumetric and gravimetric densities of the capacity, the energy, and the power, and cyclability in the case of secondary batteries, followed by derivatives of crystalline LiMn₂O₄, crystalline LiMnO₂, and crystalline LiNiO₂. Doping these main parent cathode materials with other transition metals (leading to derivatives) such as Sc, Ti, V, Cr, Mn, Fe, Co, Ni, Cu, Zn, Y, Zr, Nb, Mo, Ru, Rh, La, Hf, Ta, W, and Re and main group elements selected from the groups 1, 2, 13, 14, 15, 16 and 17 has been found to alter the properties of LiCoO₂, LiMn₂O₄, LiMnO₂, and LiNiO₂ with only little if any overall improvement.

According to the Teledyne U.S. Pat. No. 6,280,875, native titanium oxide on a Ti substrate is not inert enough to prevent adverse reactions from occurring between a Ti substrate and the battery components. This approach is severely restricted, because the choice of substrate materials is limited to materials capable of forming a native surface oxide during the anneal step of the positive cathode. Apart from the present invention, metallic substrates including flexible foils that do not form a native surface oxide have not been employed successfully as thin-film battery substrates. Fabricating solid-state, thin-film secondary batteries by depositing, for example, high-temperature cathode materials directly onto metallic substrates, including flexible foils, other than Zr and then annealing at high temperature, such as 700° C. in air for 1 hour, may result in the positive cathode and substrate materials reacting detrimentally to such an extent that the positive cathode is rendered useless. Pure Ti and Zr substrates are also relatively expensive.

Prior thin film batteries do not disclose the use of an effective barrier layer between the substrate and the battery, and, therefore, provide potential negative observations. A need exists for the present invention such as, for example, including an inventive barrier layer and/or, for example, potential sub-layering attributes to overcome certain problems of prior thin film batteries.

### SUMMARY OF THE INVENTION

The number of portable and on-board devices continues to increase rapidly while the physical dimensions available may decrease. The batteries that run these devices should keep pace with the demands of the devices served, potentially shrinking in size while, for example, delivering the same power. The thinner the batteries become, the more applications they may serve. One enabling power device is the thin-film, solid-state battery. When footprint is a limiting factor but capacity demand is still “high,” it becomes important to pack and stack as many battery cells as possible into the space (footprint×height) available.

The batteries with the highest capacity, voltage, current, power, and rechargeable cycle life may, for example, take advantage of today's powerful positive cathode materials, LiCoO₂, LiMn₂O₄, LiMnO₂, LiNiO₂, and derivatives thereof.

When vacuum deposited into thin films, these materials may require post-deposition annealing at high temperatures in order to improve their crystallinity, which is directly related to development of their full range of electrochemical properties. For an electrochemical apparatus, which employs such a thin-film battery, to become thinner, mainly the inert, electrochemically inactive part of the electrochemical apparatus should become thinner. One approach is to build the battery on thin, metal foil substrates instead of thick, bulky ceramic ones. Metal foils are more flexible, thinner, and less expensive than ceramic substrates of the same footprint. Furthermore, they are easily available in much larger areas which translates into substantial cost savings in manufacturing.

However, LiCoO₂, like other positive cathode materials, is a strong oxidizer and possesses very mobile and thus reactive lithium ions. At the high annealing temperatures necessary to crystallize the as-deposited LiCoO₂ film, it reacts strongly with most metals and alloys as well as with many compounds, except for a limited number of inert ceramics. In other cases, unwanted species from the substrate may diffuse into LiCoO₂ during the high annealing temperatures and contaminate the positive cathode thereby detrimentally altering its electrochemical properties. If the annealing temperature is kept sufficiently low to prevent reactions or unwanted diffusion, then the cathode may not fully crystallize, and capacity, energy, current, and power capability, and, in the case of rechargeable batteries, lifetime (number of cycles) may suffer.

High-power cathode materials may unfold their full, desirable, electrochemical properties in their crystalline state. Because these materials may, for example, be used in the present invention in thin-film form, they may typically be deposited by one of the common vapor phase thin-film deposition methods, such as sputter deposition (RF, pulse DC, or AC), electron-beam evaporation, chemical vapor deposition, plasma enhanced chemical vapor deposition, spray pyrolysis, ion-assisted beam evaporation, electron-beam directed vapor deposition, cathodic arc deposition, etc. These vapor phase methods may not produce cathode films in the as-deposited state that exhibit comparable electrochemical properties to cathodes that are fabricated from their respective, well-crystallized powders used in bulk batteries, such as cell phone and camcorder type batteries. Thus, the inferior electrochemical properties of such cathodes deposited by thin-film methods may be attributed to the lack of the necessary degree of crystallinity in the as-deposited state. The degree of crystallinity, however, may be improved by a post-deposition anneal at higher temperatures, typically between 200-900° C., better between 500-850° C., and even better between 650-800° C. Atmospheres used in these anneals are typically air, O₂, N₂, Ar, He, H₂, H₂O, CO₂, vacuum (P<1 Torr), or mixtures thereof. To achieve sufficient crystallization and hence improved electrochemical properties, annealing times should, for example, be extended when reducing the annealing temperature below about 650° C. The rate of crystallization may be exponentially activated by temperature and thus decreases significantly with decreased annealing temperature. If the anneal temperature is lowered too much, then the applied energy from the annealing temperature may not be sufficient to overcome the thermal activation energy necessary for the crystallization process to occur at all. For example, a 900° C. anneal in air for 15 min may yield the same degree of crystallinity in magnetron-sputtered LiCoO₂ films as about an 1 h anneal in air at 700° C. and as about an 12 h anneal in air at 600° C. After annealing at 400° C. in air for 24 h the electrochemical quality of magnetron-sputter-deposited LiCoO₂ cathode films may remain poor and unimproved after 72 h at that temperature. Thus, LiCoO₂ cathode films fabricated via vapor phase methods may be post-deposition annealed at 700° C. in air for about 30 min to 2h. This relatively high annealing temperature, however, may cause chemical compatibility issues, thereby rendering such an annealing step potentially undesirable in the fabrication process of thin-film batteries, as well as increasing the cost and reducing the fabrication throughput.

Post-deposition annealing conditions may severely limit the choice of substrate materials. Not only should substrates preferably be able to withstand the high annealing temperatures (T>500° C.), but they should also preferably be chemically inert against all battery film materials that are in contact with said substrate in regards to the anneal atmosphere and battery operation and storage conditions applied. Likewise, the substrate should not be a source of impurities that can diffuse into the battery film materials during fabrication or thereafter during battery operation. Such impurities may poison any of the battery film materials and diminish, severely impact or even destroy battery performance and lifetime. Certain choices of substrates may be, for example, restricted to chemically inert, high-temperature ceramics, for example, Al₂O₃, MgO, NaCl, SiC, and quartz glass. Two metals, Zr and Ti, for example, have demonstrated limited success as metallic substrates.

Although the above-mentioned ceramics have demonstrated their ability to withstand high temperatures without chemical reactions during the thin-film battery fabrication, there may be significant drawbacks to using them in cost-effective manufacturing of thin-film batteries. Ceramics tend to be at least 5 mil≈125 μm thick, brittle, inflexible (rigid), and relatively expensive per given footprint. Also, their sheer area size may be limited. The thinner the ceramic substrate becomes, the smaller is the maximum area that can safely be handled without breaking said ceramics. For example, 12 inch×12 inch plates of ¼ inch thick Al₂O₃ are commercially readily available. However, thinned and polished Al₂O₃ ceramic substrates of 10 mil 250 μm in thickness reduce the area that can be fabricated with reasonable yields to approximately 4 inch×4 inch boards. Thin (<20 mil or <500 μm), 4 inch×8 inch polished ceramic boards are available as custom orders, but not as a routinely stocked item at acceptable prices for large scale manufacturing of thin-film batteries.

Due to their fragile character below about 100 μm, the use of ceramics as a substrate material for thin-film batteries may become impractical (despite the discussion by Front Edge Technology in U.S. Pat. No. 6,632,563, discussing Mica substrates with thicknesses below 100 μm). One the properties of Mica is its extremely brittle and fragile character, even at much greater thicknesses than 100 μm. Using ceramic substrates thicker than 100 μm, however, may cause the electrochemically inactive mass and volume of the substrate to make up more than 90% of the total battery weight and volume, which may be undesirable.

For all of these stated reasons non-ceramic foils may be used as thin-film battery substrates. Under non-ceramic substrates, including, for example, metallic and polymeric substrates, silicon and doped silicon may assume an intermediate position.

Non-ceramic foils, for example, may offer advantages as substrates for thin film batteries, provided the substrate material is able to withstand the processing conditions, including temperature and, for example, contacting certain potentially reactive battery layers. Relative to ceramic substrates of a given footprint, non-ceramic foil substrates can be thinner, more flexible, less expensive, readily available in larger sizes, and may decrease the overall thickness of the battery (electrochemical apparatus) while reducing the electrochemically inactive mass and volume of the entire battery, which in turn may increase the battery's capacity density, energy density, and power density. Non-ceramic foils are, for example, available in rolls of 0.5-5 mil 12-125 μm in thickness, up to several meters wide, and up to many meters in length. Substrates that come in long rolls present the possibility of roll-to-roll fabrication at much lower costs than the typical batch mode fabrication processes currently in practice. Fabricating a thin-film battery on a thinner, more flexible substrate without compromising battery performance, compared to a thin-film battery fabricated on a thick rigid substrate, plays a role in enabling certain applications for the thin-film battery technology.

Reducing the electrochemically inactive mass and volume of the battery by making the substrate thinner significantly may increase the capacity density, the energy density, and the power density of the battery per mass and volume. For example, a given application may allot a volume for the battery of 2 cm×2 cm×0.1 cm. Currently, there are no traditional button cell or jelly roll (spiral wound or prismatic) batteries available that can physically fit in that volume. In contrast, a thin-film, solid-state battery may fit that volume because even when fabricated onto a ceramic substrate of 0.05 cm, the entire battery, including an optionally protective coating, is much thinner than 0.1 cm. Fabricating a thin-film battery on a 2 mil=50 μm=0.005 cm thick foil substrate with the same footprint and same battery capacity may further allow the stacking of a maximum of 20 batteries into said volume. The actual number of batteries is determined, for example, by the thickness of each battery cell including its substrate and its optional protective coating. Nevertheless, the capacity density, energy density, and power density all may be increased by a manifold when using a thin non-ceramic foil substrate instead of a thick ceramic one.

Thin-film batteries may, for example, be fabricated by sequentially depositing the individual battery component layers on top of each other. As mentioned, examples of the best positive cathodes include (but are not limited to) LiCoO₂, LiMn₂O₄, LiMnO₂, LiNiO₂, and derivates thereof and may require a post-deposition anneal at temperatures well above 500° C. in order to crystallize completely, thereby achieving their full electrochemical properties. Because certain known solid-state lithium electrolytes may react destructively when in contact with said high-temperature positive cathodes at these high temperatures, the positive cathode should be deposited and annealed before depositing the electrolyte layer.

Positive cathode materials may generally be considered poor semi-conductors, at least over some range of their state of charge during battery operation. To get maximum power out of the battery and into the external circuit, the positive cathode layer may be deposited onto a metallic back contact, the cathode current collector (CCC) layer. This CCC also should undergo the high-temperature cathode anneal and not react with the positive cathode at the same time. For this reason, a noble metal such as gold or an alloy thereof may be used.

The facts outlined above suggest that for improvement in the performance of batteries, positive cathode materials may be deposited as the second layer of said batteries immediately after the deposition of the CCC. The post-deposition anneal of said positive cathode layer may, therefore, accomplishes its crystallization before the next fabrication step, the electrolyte deposition. Due to the close proximity of said high-temperature cathode material to the substrate, which may only be separated from each other by a relatively thin CCC (0.1-1 micro-meter), strong detrimental interdiffusion and reaction of the positive cathode and the substrate have been observed when not using ceramic substrates but instead high-temperature stable metallic foils, such as stainless steel. This interdiffusion may, for example, not be blocked out by the metallic CCC itself for three main reasons: First, the CCC film is relatively thin (0.1-1 μm) thereby representing only a thin pseudo-diffusion barrier. Second, the CCC exhibits a crystalline grain structure. Grain boundaries may be the usual locations for ionic and electronic diffusion and conduction so that the CCC should be viewed as inherently permeable for ions and electrons from both the adjacent positive cathode layer and the adjacent metallic foil substrate. Thus, during the cathode anneal step, the foil substrate material and cathode film material may interdiffuse while, third, the metallic CCC alloys directly into the metallic foil substrate and may lose its good current collecting properties.

The thickness of the CCC is determined, for example, by cost, mass, volume, and adhesion, which all may become technologically impractical when fabricating the CCC thicker than about 2 μm, especially when using a costly noble metal such as gold. Potentially, significantly thicker CCC films of about more than 5 micro-meters may avoid interdiffusion depending, for example, on temperature and pertinent dwell time of the annealing step. However, the use of such a thick CCC may, for example, incorporate increased materials costs and potentially unreliable adhesion.

Replacing ceramic substrates with metal foil substrates introduces tremendous opportunities for enabling new technologies using thin-film batteries, in addition to the mere reduced fabrication costs over thin-film batteries fabricated onto ceramic substrates. In contrast to ceramic plates, metallic foils are commercially readily available in thicknesses of less than 75 μm with some materials available as thin as 4 μm. These foils are much more flexible than their ceramic counterparts, contribute less structural, inactive mass to the battery, and, most importantly, substantially reduce the overall thickness of the complete thin-film battery device. It should be emphasized that minimizing the overall thickness and increasing the flexibility of said battery is critically important for most thin-film battery applications. Thinner thin-film battery devices are able to fit into new, physically smaller applications. What was once not practical with a button cell battery now becomes possible with a thin-film battery (i.e. smart cards, etc.). The added flexibility of a foil substrate further, for example, allows conformation to new, non-planar shapes.

Furthermore, thin metal foils may generally cost less than ceramics per footprint area and come in much larger sizes such as rolls. With the availability of flexible, large area substrates, the potential exists for developing roll-to-roll fabrication methods thereby further reducing production costs.

New applications may, for example, be enabled with a thin-film battery that provides uncompromised or improved performance relative to state-of-the-art thin-film battery that is fabricated on ceramic substrate. In this regard the present invention may include the deposition of an interdiffusion barrier layer onto metallic foil substrates where this barrier layer chemically separates the battery part from the substrate part during high and low post-deposition anneal temperatures, for example, in the range between 100-1000° C., as well as all battery operation and storage conditions while not becoming a source of impurities itself (See FIG. 1).

The barrier may, for example, prevent diffusion of any contaminants entering the battery from the substrate as well as, for example, blocking ions from escaping the battery and diffusing into the substrate during both battery fabrication and during battery operating and storage conditions. Such a barrier layer may not, for example, exhibit a grain structure at any time; that is, it may be amorphous or glassy in its as-deposited state and remain as such throughout the entire annealing and battery fabrication process as well as during battery operation and storage conditions. The absence of a grain structure in the barrier layer may avoid the detrimental grain boundary diffusion or conduction of ions and electrons. As mentioned earlier, grain boundaries are the pathways along which impurities and contaminants may travel. When certain of these conditions are met, the thin-film batteries fabricated on metallic substrates, flexible & thin or less flexible & thicker, may exhibit properties comparable to, for example, thin-film batteries fabricated on chemically inert yet thick and heavier, rigid, and expensive ceramic substrates.

Certain potentially suitable materials for the diffusion barrier layer may be poorly ion conducting materials such as borides, carbides, diamond, diamond-like carbon, silicides, nitrides, phosphides, oxides, fluorides, chlorides, bromides, iodides, and any multinary compounds thereof. Of those compounds, electrically insulating materials may further prevent possible reactions between the substrate and the battery layers to occur, because for example, if these chemical reactions require the diffusion of ions and electrons, then blocking electrons is one means of blocking these example chemical reactions. However, electrically conducting materials may be used as well, for example, ZrN, as long as they are preferably not conducting any of the ions of the substrate or battery layer materials. In some cases metals, alloys, and semi-metals may serve as a sufficient barrier layer depending on the anneal temperatures applied during the battery fabrication process and substrate material used. The diffusion barrier layer may either be single or multi-phase, crystalline, glassy, amorphous or any mixture thereof, although glassy and amorphous structures are usually used due to their lack of grain boundaries that would otherwise serve as locations for increased, but unwanted, ion and electron conduction.

Because certain materials block out the conduction of a wide variety of ions, they may also be used in certain non-lithium containing thin-film battery, such as batteries whose electro-active ions are beryllium, sodium, magnesium, potassium, calcium, boron, and aluminum. The thickness of said diffusion barrier layer may, for example, range from 0.01 micro-meters to 1 mm.

Although the barrier layer concept and principles for thin-film batteries of the present invention have initially been developed for metallic substrates, the same barrier layer materials may, for example, be deposited onto polymeric substrates and doped and undoped silicon wafers whose associated thin-film battery applications are also of commercial interest. The post-deposition anneal temperatures may, for example, be lower than the melting point of the silicon or polymeric substrates used, irrespective of the barrier layer applied in order to, for example, avoid melting of the substrate.

The present invention relates, for example, to a method for fabricating flexible, high-capacity, solid-state, thin-film batteries on thin foil substrates, for example, metallic substrates. These batteries retain all of the capacity, energy, power, and lifetime of otherwise equally fabricated batteries on chemically inert, relatively thick, rigid ceramic substrates. The success of this approach is attributed to the utilization of an appropriate, chemically inert diffusion barrier layer between the substrate and the thin-film battery which may effectively separate these two parts of the electrochemical apparatus. The diffusion barrier layer should, preferably, be able to withstand the high annealing temperatures that may be applied to the thin-film battery part during its fabrication onto the substrate, be chemically inert to both the substrate and the thin-film battery part, not be a source of impurities, at least not for the thin-film battery part, and keep the thin-film battery part chemically separated from the substrate under all operating and storage conditions of the electrochemical apparatus after its completed fabrication. Additionally, the barrier layer should, preferably, prevent diffusion of any contaminants attempting to enter the thin-film battery part from the substrate as well as block Li ions from escaping the thin-film battery part and diffusing into the substrate during both battery fabrication and all battery operating and storage conditions. As an added benefit, the barrier layer may also protect the substrate during processing from the atmosphere applied during the post-deposition anneal and from any of the thin-film battery components already present at that fabrication stage of the unfinished electrochemical apparatus.

Diffusion barrier layer materials of the present invention may include, but are not limited to, single or multiple thin-films of amorphous Si₃N₄, SiC, ZrN, and TiC, among others. These are exemplary of compounds which may effectively serve as barriers due to their ion blocking properties, amorphous structure, and chemical inertness to the substrate as well as to the battery part of the electrochemical apparatus. The pre-eminent characteristics of these barrier layer chemistries are their inherent ability to retain their amorphous, as-deposited state and their diffusion blocking properties up to substantially high temperatures, for example 700° C., and for longer periods at those temperatures, for example 2 hours, during the preferred LiCoO₂ crystallization post-deposition anneal process. As a result, batteries fabricated on metal foils with such barrier layers retain the best electrochemical properties known of equivalently configured thin-film batteries that are fabricated onto ceramic substrate, but with the added benefits of being flexible, much thinner, and cheaper.

The present invention further, for example, relates to fabricating an appropriate barrier layer onto substrates in conjunction with a subsequent thin-film battery fabrication where the barrier layer may chemically separate the substrate from the battery part during the battery fabrication as well as during battery operation and storage conditions thereafter. Polymeric substrates and doped and undoped silicon substrates may be used in addition to metallic substrates.

One object of an embodiment of the present invention is to provide an electrochemical apparatus with a metallic substrate, with a battery on only one side of the substrate.

One object of an embodiment of the present invention is to provide an electrochemical apparatus with a metallic substrate, with two batteries, one on each side of the substrate.

Another object of an embodiment of the present invention is to provide an electrochemical apparatus with a polymeric substrate, with a battery on only one side of the substrate.

Another object of an embodiment of the present invention is to provide an electrochemical apparatus with a polymeric substrate, with two batteries, one on each side of the substrate.

A further object of an embodiment of the present invention is to provide an electrochemical apparatus with a doped or undoped silicon substrate, with a battery on only one side of the substrate.

A further object of an embodiment of the present invention is to provide an electrochemical apparatus with a doped or undoped silicon substrate, with two batteries, one on each side of the substrate.

Another object of an embodiment of the present invention is to provide a method of fabricating an electrochemical apparatus with a metallic substrate, with a battery on only one side of the substrate.

Another object of an embodiment of the present invention is to provide a method of fabricating an electrochemical apparatus with a metallic substrate, with two batteries, one on each side of the substrate.

Another object of an embodiment of the present invention is to provide a method of fabricating an electrochemical apparatus with a polymeric substrate, with a battery on only one side of the substrate.

Another object of an embodiment of the present invention is to provide a method of fabricating an electrochemical apparatus with a polymeric substrate, with two batteries, one on each side of the substrate.

A further object of an embodiment of the present invention is to provide a method of fabricating an electrochemical apparatus with a doped or undoped silicon substrate, with a battery on only one side of the substrate.

A further object of an embodiment of the present invention is to provide a method of fabricating an electrochemical apparatus with a doped or undoped silicon substrate, with two batteries, one on each side of the substrate.

### BRIEF DESCRIPTION OF THE DRAWINGS

FIG. 1 illustrates an exemplary schematic of a chemical separation of the substrate part from the battery part of the electrochemical apparatus via a barrier layer.

FIG. 2a illustrates a schematic of an exemplary use of an embodiment of an electrically conductive barrier layer on metallic substrate for the case where the electrical separation between the positive and negative part of the battery is accomplished through fabrication of the negative part entirely on top of the electrolyte.

FIG. 2b illustrates another schematic of an exemplary use of an embodiment of an electrically conductive barrier layer on metallic substrate for the case where the electrical separation between the positive and the negative part of the battery is accomplished through fabrication of the negative part entirely on top of the electrolyte.

FIG. 3 illustrates a schematic of an example of an embodiment of an electrically conductive barrier layer consisting of individual sub-layers for the case where the electrical separation between the positive and the negative part of the battery is accomplished through fabrication of the negative part entirely on top of the electrolyte.

FIG. 4a illustrates a schematic of one example of an embodiment of an electrically conductive barrier layer consisting of individual sub-layers for the case where the electrical separation between the positive and negative part of the battery is not done via fabrication of the negative part entirely on top of the electrolyte.

FIG. 4b illustrates a schematic of another example of an embodiment of an electrically conductive barrier layer consisting of individual sub-layers for the case where the electrical separation between the positive and the negative part of the battery is not done via fabrication of the negative part entirely on top of the electrolyte.

FIG. 5 illustrates a schematic of one example of an embodiment of an electrically conductive barrier layer consisting of individual sub-layers for the case where the electrical separation between the positive and the negative part of the battery is not done via fabrication of the negative part entirely on top of the electrolyte.

FIG. 6 illustrates a graph of an X-ray diffraction (XRD) pattern of a 1.6 μm thick LiCoO₂ positive cathode film fabricated onto 3000 Å gold cathode current collector over 300 Å cobalt adhesion layer over a gradiented, insulating barrier layer composed of 1000 Å SiO₂ /5000 Å Si₃N₄/1000 Å SiO₂ on 50 micro-meter thick stainless steel foil type 430 substrate.

FIG. 7 illustrates a graph of an electrochemical cycle performance of an electrochemical apparatus.

FIG. 8 illustrates a graph of an X-ray diffraction (XRD) pattern of a 1.6 μm thick LiCoO₂ positive cathode film fabricated onto 3000 Å gold cathode current collector over 300 Å cobalt adhesion layer over a gradiented, insulating barrier layer composed of 1000 Å SiO₂/5000

A Si₃N₄/1000 Å SiO₂ on 400 micro-meter thick undoped silicon substrate.

FIG. 9a illustrates a schematic of an example of an embodiment of an anode configuration of the “normal configuration” in which the negative anode is not in direct contact with the barrier layer.

FIG. 9b illustrates a schematic of an example of an embodiment of an anode configuration of the “normal configuration” in which the negative anode is in direct contact with the barrier layer.

FIG. 10 illustrates a schematic of an example of an embodiment of an anode configuration of the “normal configuration” in which the negative anode is in direct contact with an electrically conductive ZrN barrier sub-layer that also serves as the anode current collector.

FIG. 11 illustrates a schematic of an example a specific battery configuration in which the negative anode is in direct contact with the substrate in case the substrate is chemically inert to the negative anode.

### DETAILED DESCRIPTION OF THE INVENTION

It should be understood that this invention is not limited to the particular methodology, protocols, etc., described herein and, as such, may vary. The terminology used herein is for the purpose of describing particular embodiments only, and is not intended to limit the scope of the present invention, which is defined solely by the claims.

As used herein and in the claims, the singular forms “a,” “an,” and “the” include the plural reference unless the context clearly indicates otherwise.

All patents and other publications identified are incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason.

Unless defined otherwise, all technical terms used herein have the same meaning as those commonly understood to one of ordinary skill in the art to which this invention pertains. Although any known methods, devices, and materials may be used in the practice or testing of the invention, the preferred methods, devices, and materials in this regard are described here.

Thin-film batteries may, for example, be fabricated in batch mode by depositing the individual battery component layers sequentially. Once a substrate material has been selected, it may be prepared by cleaning and, if desired, other pre-treatments. The barrier layer, which may be 0.5-5 μm thick, is the key to successful fabrication of thin-film batteries on metallic and polymeric foils as well as silicon. The barrier layer should be able to withstand the annealing temperatures for the positive cathode film together with the cathode current collector, remain chemically inert, and not be a source of impurities. Additionally, the barrier layer should prevent diffusion of any contaminants entering the cathode from the substrate as well as block all ions and atoms from the positive cathode and the cathode current collector from diffusing into the substrate during both the battery fabrication and all battery operating and storage conditions. The barrier layer may be deposited onto the clean substrate and typically coats the substrate everywhere with a uniform, defect-free film. The ensuing battery layers may then be deposited sequentially in batch fashion using shadow masks to demarcate the boundaries of each layer of the thin-film battery. The barrier layer may be designed and fabricated to isolate the effects of grain boundary diffusion, thereby eliminating reactions between the subsequently deposited cathode, such as LiCoO₂, with its underlying cathode current collector and the substrate, such as a gold cathode current collector and a flexible stainless steel foil substrate, respectively. The following presents exemplary ways of depositing embodiments of barrier layers and sublayers onto substrates onto which thin-film batteries are fabricated.

1. Substrate Selection and Preparation

First, the substrate material may be chosen. The thin-film batteries may be fabricated on a variety of metallic foils and sheets with varied surface finishes. A thin foil of stainless steel may be used for the substrate. However, other, more expensive and thicker materials or lower melting materials work as well, including, but are not limited to, Ti and Ti-alloys, Al and Al-alloys, Cu and Cu-alloys, and Ni and Ni-alloys, for example. Additionally required physical properties of the foil, such as type of steel of alloy, surface roughness, homogeneity, and purity, are left to the user to determine the optimum manufacturing parameters for the particular device.

Once the stainless steel foil material, for example, has been selected, it is generally cleaned in order to remove oils, particulates, and other surface contaminants that would otherwise impede chemical or mechanical adhesion of the barrier layer to the substrate. Any cleaning procedure, for example, any suitable wet chemical cleaning or plasma cleaning process that provides a sufficiently clean surface, may be used in this regard. Optionally, the cleaned foil substrate may be further pre-treated, if so desired. For example, to relieve the intrinsic stress of metallic foils, an anneal step at high temperatures (e.g. 500° C.) prior to depositing the barrier layer may be employed, provided that the anneal temperature remains below the melting point of the metallic foil.

Although substantially independent of any foil material and its thickness, several annealing strategies may further reduce or accommodate thermal and mechanical stresses on a film-by-film basis. For example, pre-annealing a cleaned foil may be performed as described above to condition an uncoated metal foil. Additionally, other annealing steps may include, for example, a post-deposition barrier layer anneal, a post-deposition cathode current collector layer anneal, or any combination of post-deposition layer anneals prior to the cathode crystallization anneal. Such steps may be preceded or followed by additional plasma treatments (See D. Mattox, Handbook of Physical Vapor Deposition (PVD) Processing, pp. 660ff and 692ff). Analogously, silicon and polymeric substrates can be prepared.

2. Barrier Layer Deposition

Depositing a barrier layer onto substrates may be performed in conjunction with thin-film battery fabrication that, for example, chemically separates the substrate from the battery part during the battery fabrication as well as, for example, during battery operation and storage conditions thereafter.

An electrically insulating barrier layer, such as Si₃N₄, for example, may be deposited directly onto the substrate where this barrier layer has diffusion blocking properties with regard to electrons, ions, and atoms from the substrate and the battery layers. In general, chemical reactions between potential reactants may be prevented when either their ions or their electrons are confined to each of the reactants' space or blocked at the reactants' interface so that preferably no interdiffusion of these species between the potential reactants is possible.

A precursor layer, such as a metal for example cobalt, may be deposited and then processed further, such as annealing in air, in order to obtain an insulating barrier layer, such as CO₃O₄, for example. This insulating barrier layer may or may not have adequate diffusion blocking properties, which is sufficient though, because chemical reactions between the substrate and the battery layers are preferably avoided due to the electron insulating properties of the barrier layer.

An electrically conductive material, such as ZrN, for example, that possesses adequate diffusion blocking properties relative to ions so as to chemically separate the substrate from the battery part in the electrochemical apparatus, may be deposited. In this case, the conductive barrier layer may also serve as a current collector.

Stress balance around the substrate may be ensured which otherwise may deform, wrinkle, and warp during the battery fabrication process, specifically when using thin substrates in conjunction with a post-deposition anneal step for any of the layers, including the barrier layer itself. Such mechanical deformation of the substrate is not preferred as part of the reliable fabrication of thin-film batteries onto substrates.

The combination of the basic steps above leads to the concept of a barrier layer that is, for example, composed of individual sub-layers with different specific properties with the objective to fine-tune the barrier layer properties. This concept is considered one exemplary principle in regarding fabricating and providing a barrier layer that preferably chemically separates the substrate from the battery part of the electrochemical apparatus while allowing the reliable fabrication of such apparatus.

2.1 Direct Deposition of an Electrically Insulating Barrier Layer

An insulating diffusion barrier layer may be directly deposited onto the substrate. An amorphous or glassy barrier layer may be designed and fabricated to avoid or minimize grain boundary diffusion of ions and electrons, thereby reducing the diffusion of unwanted species into and out of the battery layers during fabrication and during operation and storage conditions of the battery thereafter. It is preferable to prevent or minimize chemical reactions between the battery components with the substrate.

The barrier layer may be selected from a group of materials that may block the diffusion of ions from a LiCoO₂ cathode layer (lithium ions, cobalt ions, and oxygen ions), atoms from the current collector (gold, platinum, nickel, copper, etc.), and ions from the stainless steel substrate (iron ions, chromium ions, nickel ions, other heavy metal ions and main group atoms and ions of the selected stainless steel type), although it may, for example, be sufficient to use simply electrically insulating materials that are inert to the substrate, the current collector, and/or the positive cathode. Selecting a barrier layer that is capable of blocking ions and electrons may be considered a preferable approach regarding obtaining a substrate part and the battery part of the electrochemical apparatus that may be chemically separated during fabrication and during operation and storage conditions of the electrochemical apparatus thereafter.

The group of binary borides, carbides, silicides, nitrides, phosphides, oxides, fluorides, chlorides, bromides, and iodides, as well as diamond and diamond-like carbon may provide general ion blocking properties in addition to electrical insulation properties. Therefore, these materials may be used for the barrier layer material. In addition to using preferably the binary compounds of these materials, the barrier layer may, for example, be formed of any multinary compound composed of these materials such as, but not limited to, oxy-nitrides, carbo-borides, carbo-oxy-nitrides, silico-carbo-nitrides, and oxy-fluorides.

The above-listed binary and multinary barrier layer materials may be deposited by selecting one or more of the many suitable thin-film deposition methods including sputtering (RF-magnetron, DC-[pulse] magnetron, diode RF or DC, AC), electron beam evaporation, thermal (resistive) evaporation, plasma enhanced chemical vapor deposition, ion beam assisted deposition, cathodic arc deposition, electrochemical deposition, spray pyrolysis, etc. A Si₃N₄ barrier layer, for instance, may be fabricated by utilizing a pure silicon target that is sputtered preferably in a RF magnetron sputter system using an Ar—N₂ reactive plasma environment. SiC and TiC films are usually RF magnetron sputtered from targets of the same respective composition in an inert Ar plasma environment while their nitrogen doped derivatives, SiC:N and TiC:N, are deposited from SiC and TiC targets, respectively, in a reactive Ar—N₂ plasma environment using RF magnetron sputter equipment.

The formation of optimized oxy-nitrides, carbo-borides, carbo-oxy-nitrides, silico-carbo-nitrides, oxy-fluorides, and the like may be accomplished by providing sputter gas mixtures that may contain N₂, O₂, N₂O, BF₃, C₂F₆, B₂H₆, CH₄, SiH₄, etc. either alone or in addition to an inert carrier gas, such as argon, and/or in addition to providing the elements from a sputter target. For example, the thin-film deposition of titanium silico-carbo-nitride (=titanium silicon carbide nitride), Ti₃SiC₂:N, may be accomplished by RF magnetron sputtering in Ar—N₂ plasma atmosphere using either a single sputter target constructed of alternating areas consisting of TiC and SiC in an overall area ratio of 3:1 or two separate sputter targets, one consisting of TiC and the other one of SiC, that are operated in such a way that they deposit a mixed material layer having a TiC/SiC ratio of 3:1 at any given time onto the same substrate area (dual target sputter deposition). The barrier-layer coated substrate may or may not be post-deposition processed prior to continuing with the battery fabrication.

A good example for a barrier layer material may be Si₃N₄, SiNₓO_{y}, or oxide-gradiented Si₃N₄ that may reach a stoichiometry at its surface, or at both of its surfaces, of almost SiO₂, if so desired. Additionally, SiC or TiC, with or without nitrogen doping, may be a good barrier layer material.

A few specific derivatives of these materials may not be preferable as ion blockers when used as in a barrier layer without any further sub-layers, because they allow the diffusion of certain ions in the fabrication process or during battery operating and storage conditions while exhibiting only poor insulating properties, such as non-stoichiometric ZrO₂, non-stoichiometric YSZ (yttrium stabilized zirconia), and non-stoichiometric LiI (lithium iodide). In contrast to their stoichiometric counterparts, the non-stoichiometry is the main reason why these materials are electrically conductive while allowing oxygen and lithium ion diffusion, respectively.

To, for example, fine-tune certain barrier properties, such as improved adhesion to the substrate and/or the battery part, mechanical flexibility, stability to adjacent layers, pinhole-freeness, electrical resistance, and chemical inertness, suitable barrier layers may be provided that comprise individual sub-layers. For example, a barrier layer on top of a stainless steel 430 substrate may be constructed from a stack of individual sub-layers of the following sequence: 500 Å SiO₂ (for improved adhesion to the oxide-bonding stainless steel substrate)/2000 Å Si₃N₄ (insulating and diffusion blocking material towards lithium ions, cobalt ions, oxygen ions, iron ions, chromium ions, and gold atoms)/1000 Å SiC:N (strongly diffusion blocking layer relative to lithium ions, cobalt ions, oxygen ions, iron ions, chromium ions, and gold atoms)/2000 Å Si₃N₄ (insulating and diffusion blocking material towards lithium ions, cobalt ions, oxygen ions, iron ions, chromium ions, and gold atoms)/500 Å SiO₂ (adhesion facilitator to the current collector layer) onto which 300 Å cobalt current collector adhesion layer and 3000 Å gold current collector are deposited.

In some cases the insulating barrier layer may not only be in contact with the positive cathode and/or the cathode current collector but also may be in contact with the negative anode and/or the anode current collector. In any case the barrier layer may, for example, be preferably chemically inert to all materials with which it is in contact. This preferable characteristic may limit, for example, the use of a pure Al₂O₃ or SiO₂ barrier layers when in contact with a metallic lithium negative anode which otherwise might react detrimentally to Li₂O, LiAlO₂, and Li—Al alloys or Li₂O, Li₂SiO₃, and Li—Si alloys.

2.2 Deposition of a Precursor Layer with Subsequent Processing to Form an Electrically Insulating Barrier Layer

A precursor barrier layer may be deposited onto the substrate. The so-coated substrate may then be processed further to form the final barrier layer that exhibits properties as described in the previous section. Precursor materials may include metals or semi-metals, such as Co, Zr, Y, Si, etc., and may be deposited, for example, by standard vacuum processing methods including sputter deposition (RF-magnetron, DC-[pulse] magnetron, diode RF or DC, AC), electron beam evaporation, thermal (resistive) evaporation, plasma enhanced chemical vapor deposition, ion beam assisted deposition, cathodic arc deposition, electrochemical deposition, spray pyrolysis, etc.

The materials for the final barrier layer may, for example, be selected from the group of binary borides, carbides, silicides, nitrides, phosphides, oxides, fluorides, chlorides, bromides, and iodides as well as from the group of any of their multinary compounds, for example, but not limited to, oxy-nitrides, carbo-borides, carbo-oxy-nitrides, silico-carbo-nitrides, oxy-fluorides. The conversion from the precursor barrier layer to the final barrier layer may be accomplished by post-deposition processing methods such as annealing in specific atmospheres, post-deposition ion beam exposure, anodizing, carburizing, or treating chemically or electrochemically.

Ion beam sources allow the formation of a large variety of reactive, ionized species which, together with the accompanying electrons in the beam, may enable the reactive formation of an even larger number of compounds. For example, a carbon ion beam focused onto a metal or alloy film leads to the formation of carbides of that film. Analogously, films may be formed that comprise binary borides, carbides, silicides, nitrides, phosphides, oxides, fluorides, chlorides, bromides, and iodides as well as any of their multinary compounds, such as, but not limited to, oxy-nitrides, carbo-borides, carbo-oxy-nitrides, silico-carbo-nitrides, oxy-fluorides. The multinary compound formation, however, may be facilitated and better controlled by using a multitude of ion beam sources, such as an oxygen ion beam source and a nitrogen ion beam source for the formation of oxy-nitrides, focusing on simple precursor films consisting of, for example, but not limited to, silicon and silicon alloys, aluminum and aluminum alloys, tungsten and tungsten alloys, titanium and titanium alloys, zirconium and zirconium alloys. The so-obtained barrier layer may or may not be further heat-processed in specific atmospheres before continuing with the battery fabrication process.

In one example of the present invention cobalt may be deposited fast and relatively inexpensively by e-beam evaporation onto a stainless steel foil substrate followed by an air anneal at 700° C. The measured resistivity of the resulting CO₃O₄ barrier layer may be on the order of 10¹⁰ Ohm-cm to 10¹¹ Ohm-cm at 25° C., which may provide substantial electrical insulation from the conducting substrate foil. In addition, the CO₃O₄ may be thermodynamically stable with a positive LiCoO₂ cathode and its gold cathode current collector while being sufficiently inert towards a stainless steel 430 substrate foil at 700° C. in air. In this regard thin-film batteries may be successfully fabricated using a 500 Å thick Co layer that was electron beam evaporated onto a 50 micrometers thick stainless steel foil 430, which subsequently may be post-deposition annealed in air at 700° C. This approach may result in a 1 micrometer thick CO₃O₄ barrier layer onto which the thin-film battery part may be fabricated.

In another example of the present invention, zirconium may be first deposited as a metal onto the substrate, then nitrided at 700° C. in a N₂ atmosphere, and finally oxy-nitrided in air or O₂ atmosphere in the range of 200-700° C. to ZrNₓO_{y} where the ratio of x/y determines the electrical properties of the layer from highly conductive for large x/y ratios to very insulating for very small x/y ratios.

It may also possible to fine-tune the properties of the barrier layer by composing it of individual sub-layers that do not necessarily need to have the same area size, for example. Finalizing the composition of the sub-layers may be accomplished, for example, either during one single, final process step where all of the precursor sub-layers are converted into their final state at the same time or each individual sub-layer may be converted into its final composition immediately after its deposition, prior to the deposition of the subsequent sub-layer. For example, a 3-layer stack comprising 4000 Å Zr/1000 Å Au/4000 Å Co may be easily converted during one final step into a 6100 Å ZrO₂/1000 Å Au/8000 Å CO₃O₄ barrier layer upon anneal in air at 700° C. In another example, a 3-layer stack of 3000 Å SiC:O/4000 Å Zr/1000 Å yttrium (Y) may be converted during one final step into a 3000 Å SiC/6900 Å YSZ[=Y_{0.15}Zr_{0.85}O_{1.93}] barrier layer upon anneal in air at 700° C. However, if the 3000 Å SiC/4000 Å Zr/1000 Å Y 3-layer stack is converted after each layer deposition, one could accomplish, for example, a 3000 Å SiC:N/6100 Å ZrO₂ /880 Å YN barrier layer where the SiC barrier sub-layer was annealed at 700° C. in a N₂ atmosphere, the zirconium precursor barrier sub-layer treated at 700° C. in air, and finally the Y precursor barrier sub-layer at 700° C. in a N₂ atmosphere.

In another example, a 500 Å Co precursor barrier sub-layer may be first electron beam evaporated onto a stainless steel foil substrate, then post-deposition oxidized to 1000 Å CO₃O₄ in air at 700° C. before a glassy barrier sub-layer of 5000 Å Al₂O₃ is RF diode deposited on top of the 1000 Å CO₃O₄ layer. Because a glassy Al₂O₃ barrier sub-layer may block the diffusion of ions well but may not be chemically inert in contact with a positive LiCoO₂ cathode during a 700° C. air anneal, an additional 500 Å Co precursor barrier sub-layer may be deposited onto the glassy Al₂O₃ and then oxidized to 1000 Å CO₃O₄ in air prior to the deposition of a 300 Å Co/3000 Å Au cathode current collector and the positive LiCoO₂ cathode layer, which, in turn, may be post-deposition crystallized at 700° C. in air.

In some cases the insulating barrier layer may not only be in contact with the positive cathode and/or the cathode current collector but also with the negative anode and/or the anode current collector. In any case the barrier layer may be required to be chemically inert to all materials with which it is in contact. This requirement may prohibit, for example, the use of a pure CO₃O₄ barrier layer when in contact with a negative metallic lithium anode, which otherwise would react detrimentally to Li₂O, CoO, and a solid solution of Li and Co.

2.3 Direct Deposition of an Electrically Conductive Barrier Layer

Conductive barrier layers may, for example, be equally effective if, for example, they satisfy the preferable attributes of: 1) preventing ionic diffusion into or out of the battery layers; and 2) not reacting with either the substrate or the battery layers during the fabrication process and thereafter during all battery operating and storage conditions. The barrier layer, may, for example, not necessarily include electrical insulation.

The materials for the barrier layer may, for example, be selected from the group of conductive binary borides, carbides, silicides, nitrides, phosphides, and oxides as well as from the group of any of their conductive multinary compounds, for example, but not limited to, oxy-nitrides, carbo-borides, carbo-oxy-nitrides, silico-carbo-nitrides, oxy-fluorides.

In this strategy, an electrically conductive barrier layer, such as ZrN, TiN, WC, MoSi₂, TiB₂, or NiP may be deposited by standard deposition methods including sputter deposition (RF-magnetron, DC-[pulse] magnetron, diode RF or DC, AC), electron beam evaporation, thermal (resistive) evaporation, plasma enhanced chemical vapor deposition, ion beam assisted deposition, cathodic arc deposition, electrochemical deposition, spray pyrolysis, etc. onto the substrate. For example, a ZrN barrier layer may be fabricated either from a ZrN sputter target performing a DC magnetron sputter deposition in an inert Ar atmosphere or from a metallic Zr target also using DC magnetron sputter deposition but in a reactive Ar—N₂ atmosphere.

Additionally, certain metals (e.g.: Au, Pt, Ir, Os, Ag, Pd), semi-metals (e.g.: graphitic carbon, Si), and alloys (e.g.: based on Au, Pt, Ir, Os, Ag, Pd, C, and Si) may be selected in this case when the post-deposition anneal temperatures necessary to crystallize the cathode are moderate, such as 200-500° C. The electrically conductive barrier layer may or may not be heat processed further before continuing with the battery fabrication process.

The barrier layer may also comprise individual sub-layers where at least one of the sub-layers may be electrically conductive. These sub-layers may be formed from completely different compositions, such as a barrier comprising, for instance, 5000 Å ZrN/4000 Å Si₃N₄ /3000 Å WC/1000 Å MoSi₂. In addition, each individual layer may, for example, have different area dimensions so that the Si₃N₄ barrier sub-layer may extend over the entire footprint area of the metallic substrate while the ZrN barrier sub-layer only covers the area on the substrate underneath the cathode current collector while the WC and MoSi₂ barrier sub-layers are, for example, covering the entire area underneath the anode current collector while further extending into the area of ZrN. Due to its area size, the Si₃N₄ barrier sub-layer may provide electrical separation of the ZrN from the WC/MoSi₂ barrier sub-layers and thus the electrical separation between the positive and the negative parts of the battery.

If fabricated appropriately in terms of electrical accessibility from the positive battery terminal, a conductive barrier layer may have the added advantage of eliminating a separate cathode current collector, unless, for example, one chooses to optimize the electrical properties of the conductive barrier by coating it with a better conducting and inert thin layer, for example, gold. Whether or not additionally coated with such a better conducting layer, the approach of the conductive barrier may include that at the same time the anode current collector and negative anode be separated from the conductive barrier layer or sub-layer to which the positive cathode and/or its cathode current collector makes electrical contact. This separation may be achieved, for example, as follows:

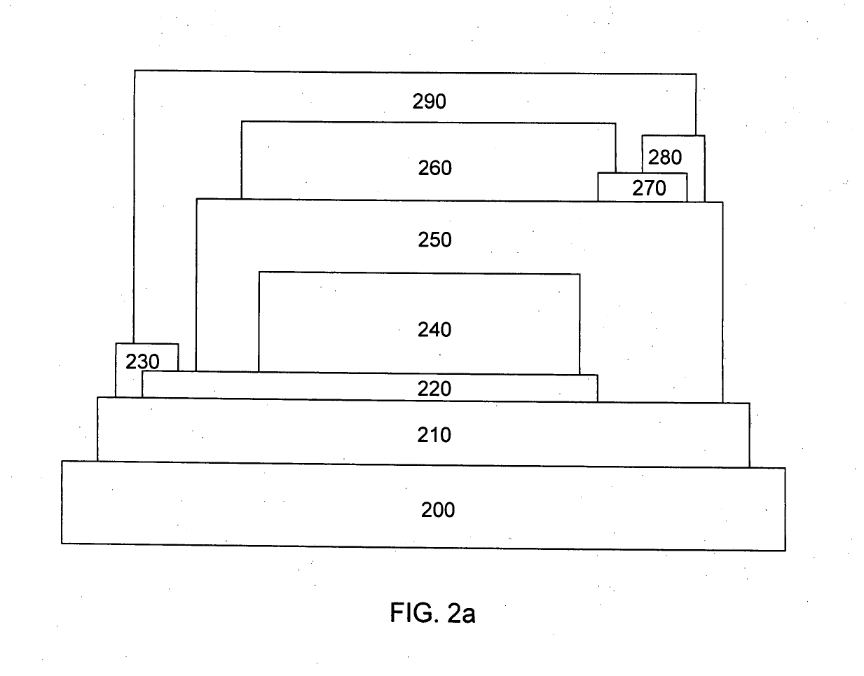

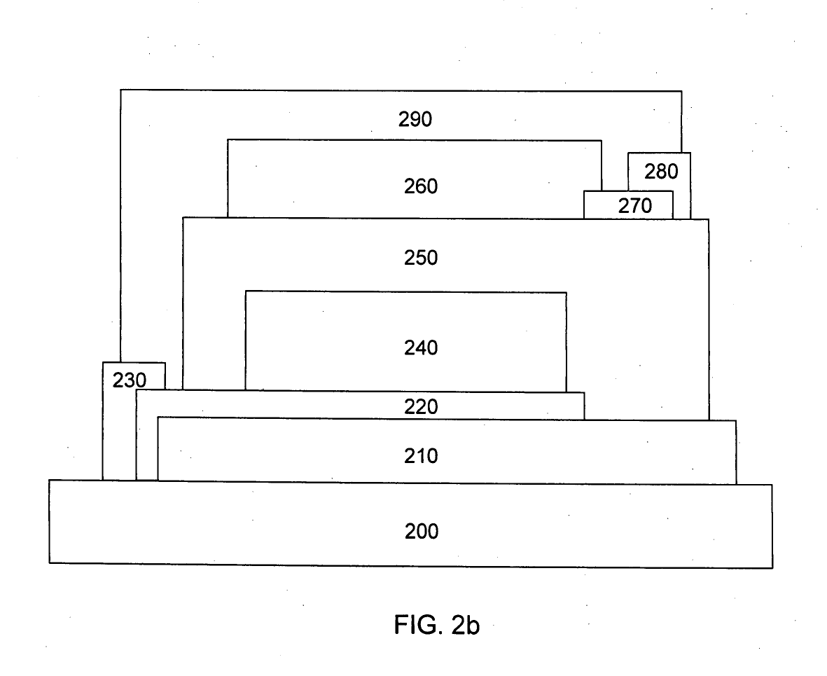

1) By extending the electrolyte in area so that both the negative anode and its anode current collector are entirely located on top of the electronically insulating electrolyte, which in turn serves in this case effectively as a local barrier layer for the negative anode and its anode current collector (See FIGS. 2a and 2b).

2) By using the above-described barrier sub-layer approach when the negative anode and the anode current collector are not located entirely on top of the electrolyte, which may cause them to make contact with the barrier layer and/or the metallic substrate. In this case one or more of the individual barrier sub-layers may be electrically conductive while at least one of the individual sub-layers should be insulating. In any case all of the barrier sub-layers should be chemically inert to all of the materials with which they are in contact. This requirement would preferably prohibit, for instance, the use of a pure Pt₂Si barrier sub-layer when in contact with a negative metallic lithium anode, because this would otherwise result in a reaction to LiₓSi for 0<x<=4.4 and Li_{y}Pt for 0<y<=2.

2.4 Double-Sided Deposition of Barrier Layer for Thin-Film Stress Balance

When depositing a barrier layer film only on one side of a substrate (single sided deposition), in particular a thin one, an inherent stress, tensile or compressive, may form that may cause the substrate to bend. Commercial batteries may be fabricated on the thinnest substrates available to the manufacturer to preferably increase the overall capacity density, energy density, and power density of the battery. The situation for a thin, single sided barrier coated substrate may worsen substantially when a subsequently deposited battery layer, such as a 3 μm thick positive LiCoO₂ cathode film, may require a post-deposition anneal at higher or high temperatures, such as 700° C. After this anneal step a thin substrate may be deformed, wrinkled, or warped strongly, thus rendering it potentially useless for the reliable completion of the thin-film battery fabrication. If the thin-film battery is successfully completed, as verified by subsequent successful battery testing, a deformed, warped or wrinkled battery may exhibit a cross-section that is contrary to what a thin-film battery preferably includes for a given device, for example: a very thin (flat) cross-section that is maintained throughout its entire geometrical footprint. However, the electrochemical apparatus of the present invention may be flexed by the customer after its complete fabrication as much as the substrate permits this flexing based on its mechanical properties.

The issue of deformation, wrinkling, and warping may be readily remedied by, for example, depositing a stress balancing, second layer onto the opposite side of the thin substrate. Practically, this may be accomplished by, for example, using the same material and thickness as the barrier layer on the first side. However, the stress balancing layer on the second side of the substrate may comprise a completely different material that may or may not have completely different barrier layer properties compared to the barrier layer on the first side. Furthermore, a relatively thin, double sided barrier layer of about 0.5 nm, in comparison to the much thicker (3 μm) positive LiCoO₂ cathode layer, having the same thickness on both sides of the thin substrate may effectively keep the thin substrate fiat during the entire fabrication process of the thin-film battery, which includes a post-deposition anneal of the [single sided] positive cathode layer. In other words, there may be no need, for example, to deposit a double sided positive cathode layer to keep the thin substrate flat during a post-deposition anneal.

For example, three very different barrier layer materials, Si₃N₄, SiC, and CO₃O₄, have been demonstrated to work very well according to this double sided layer principle. A 50 μm thin stainless steel foil substrate remains flat during a 700° C. anneal in air when 0.5 cm of either barrier layer material is double sided deposited onto this foil followed by a single sided 300 Å Co/3000 Å Au cathode current collector and a single sided 3 μm positive cathode, for which said 700° C. anneal step in air is applied.

Thus, the principle of the double sided deposition for stress balance may be applicable to any material suitable for a barrier layer as detailed above in sections 2.1, 2.2, and 2.3. Because the detrimental deformation, wrinkling, and warping mostly occurs in a single sided deposited thin substrate, in particular during a post-deposition anneal process, a double sided barrier formation may be done sequentially or simultaneously on both sides without excessively deforming, wrinkling or warping the substrate, even if thin, as long as, for example, both sides of the substrate are, for example, coated prior to any post-deposition anneal treatment. The substrate may already be equipped with a stress balancing layer on the second side of the substrate, of which at least the layer on the first side of the substrate has to be a barrier layer when the single-sided battery layers are post-deposition annealed where necessary.

In the case of a double-sided battery where both sides of the substrate carry batteries, both sides of the substrate may be coated with barrier layers, but, for example, not limited to only with one barrier layer on one side and one stress balancing layer without any barrier properties on the other. The batteries on both sides of the substrate may, for example, be deposited after the barrier layers on both sides have been fully fabricated, including a potential post-deposition treatment of the barrier layer themselves.

2.5 Barrier Layer and Substrates

One reason for providing a barrier layer is, for example, providing chemical separation between a substrate part and a battery part of an electrochemical apparatus of an embodiment of the present invention during the fabrication of the battery part, which may entail process temperatures of up to 1000° C., and thereafter during all operation and storage conditions of the electrochemical apparatus. The same principles as detailed above may apply for all three substrate types of the present invention, which may comprise metallic substrates, polymeric substrates, and doped or undoped silicon substrates.

In the case of the deposition of a precursor layer with subsequent processing to form an electrically insulating barrier layer, it may be difficult to perform a high-temperature annealing of the precursor layer when using polymeric substrates, such as the conversion of a metallic Co layer into CO₃O₄ at 700° C. in air. Instead, a lower temperature anneal at 300° C. may be applied for polymeric substrates that can withstand such conditions, such as polyimides (e.g. Kapton). A better approach for this particular Co to CO₃O₄ conversion may be the bombardment of a metallic Co layer with energetic oxygen ions from an oxygen ion gun at temperatures well below the melting point of the polymeric substrate. Analogously, ZrN and SiC, for example, may be fabricated from Zr and Si layers on polymeric substrate, respectively, that may be bombarded with nitrogen ion and carbon ion beams, respectively.

Direct depositions of electrically insulating or conductive barrier layers may be accomplished in a straightforward manner onto all three substrate types as described above. Of course, the inherent physical and chemical limitations each substrate type possesses should be observed and the deposition parameters for the barrier layer should be adjusted accordingly. For example, a sputter deposition may be performed under such high deposition rates that the resulting deposition temperature at the substrate surface exceeds the melting point of the polymeric substrate. Therefore, the deposition parameters should be limited so as to observe to the melting point of the substrate. In another example, a very thin Si substrate of only 10 micro-meters may be used. In such a case, it may be relevant to adjust the stress of the barrier layer during its deposition, neglecting any post-deposition anneal for the moment, to the mechanical properties of the fragile Si substrate in order not to crack it prior to the deposition of the second barrier on the substrate backside or prior to the deposition of the battery layers on the front side. More specific examples could be given without limiting the scope of the invention with respect to the possible use of all three substrate types and the basic principles for the fabrication of a barrier layer onto them.

3. Battery Fabrication

Once the substrate in the present invention is fabricated with a barrier layer, using the double-sided principle, then the fabrication of the battery part follows. Thin-film batteries may be manufactured in a batch fabrication process using sequential physical and/or chemical vapor deposition steps using shadow masks to build up the individual battery component layers. Batteries may be fabricated with any of several structures. The features may include:
(i) the positive cathode configuration to be used
   a. the positive cathode is located between the barrier layer and the negative anode [cathode deposition prior to anode deposition; “normal configuration”] vs. the negative anode is located between barrier layer and the positive cathode [anode deposition prior to cathode deposition; “inverted configuration”]),
   b. the post-deposition anneal that is applied to the positive cathode,
(ii) the anode configuration to be used
   a. the negative anode layer contacts or does not contact the barrier layer,
   b. the anode current collector layer contacts or does not contact the barrier layer,
(iii) the type of barrier layer to be used
   a. insulating vs. conductive,
   b. no sub-layer vs. multiple sub-layers,
(iv) the substrate is or is not in electrical contact with the battery (either with the positive battery part or with the negative battery part) and
(v) the battery is fabricated on one side (single-sided battery) or both sides of the substrate (double-sided battery).
   3.1 Cathode Configuration to be Used
   3.1.1 The Positive Cathode is Located Between the Barrier Layer and the Negative Anode, which May be Equivalent to the Deposition and Potential Post-Deposition Anneal of the Positive Cathode Prior to the Deposition of the Negative Anode: “Normal Configuration.”

Depending on the electrical properties of the barrier layer, a cathode current collector may be fabricated prior to the deposition of the positive cathode. That is, if the barrier layer, with or without sub-layers, is insulating in the area where the positive cathode is to be fabricated, then a cathode current collector may be deposited in order to create the necessary electrical access to the positive cathode from the positive terminal. If, however, the barrier layer, with or without sub-layers, is electrically conductive in the area where the positive cathode is to be deposited, then an additional inert metal layer (“conduction enhancer”) may optionally be deposited between the barrier layer and the positive cathode in order to enhance the current collecting properties of the barrier layer.

The positive cathode, the cathode current collector, and the conduction enhancer of the barrier layer may be deposited by selecting any of the many deposition methods including sputtering (RF-magnetron, DC-[pulse] magnetron, diode RF or DC, AC), electron beam evaporation, thermal (resistive) evaporation, plasma enhanced chemical vapor deposition, ion beam assisted deposition, cathodic arc deposition, electrochemical deposition, spray pyrolysis, etc.

After the deposition of the positive cathode a post-deposition anneal may follow in order to improve the physical, chemical, and electrochemical properties of the positive cathode. The most common post-deposition anneal occurs at 700° C. in air for about 30 min to 2h which completes the crystallization of today's most important positive cathode materials, LiCoO₂, LiMn₂O₄, LiMnO₂, LiNiO₂, and derivatives thereof.

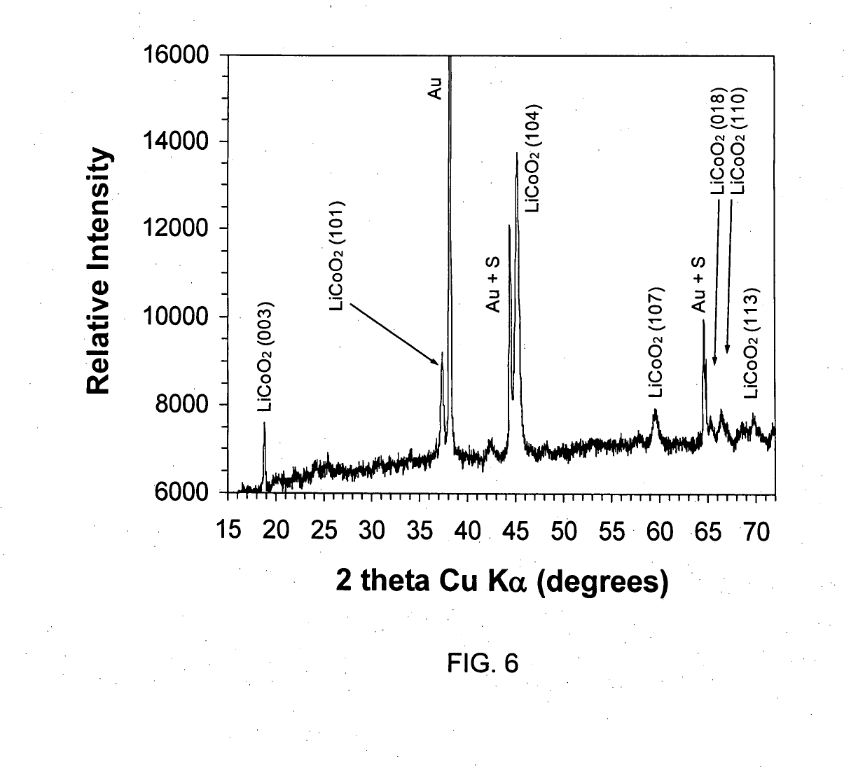

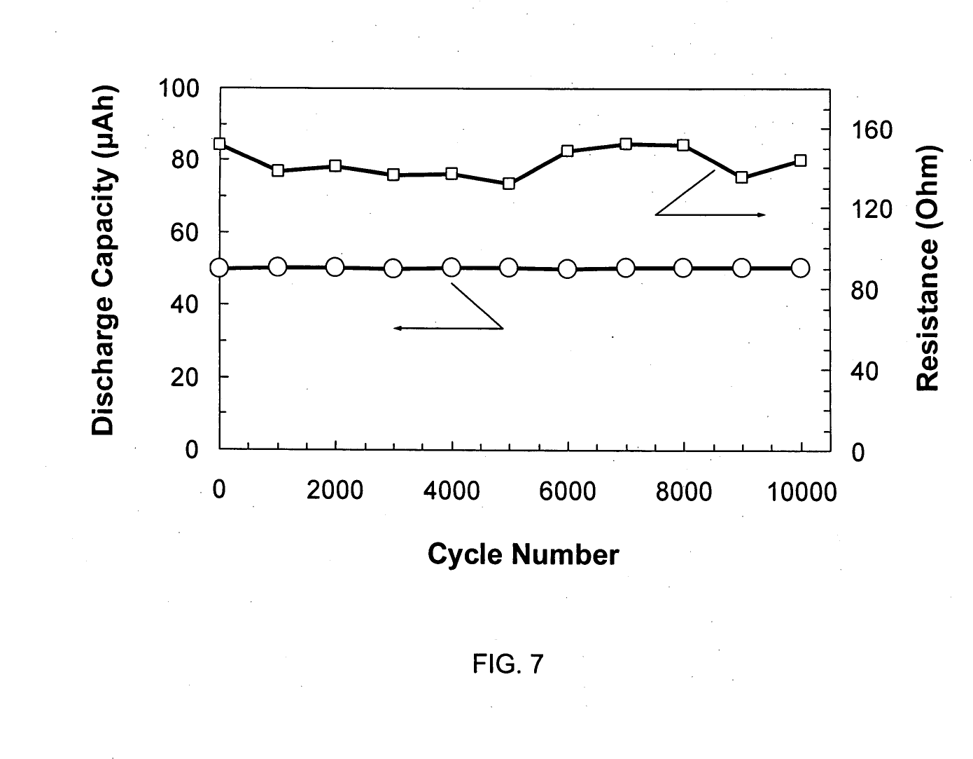

The composition of a given derivate and the parameters of the applied post-deposition anneal may inform the selection of the barrier layer material. For example, for pure LiCoO₂ and a 700° C. anneal in air for 2 h a 3000 Å gold cathode current collector that is attached by a 300 Å cobalt adhesion layer to a barrier layer of gradiented 1000 Å SiO₂ /5000 Å Si₃N₄ /1000 Å SiO₂ on 50 micro-meter of stainless steel 430 foil is one optional combination. The X-ray diffraction (XRD) pattern of this setup after the 700° C. anneal is shown in FIG. 6. As indicated by the absence of any related peaks in the XRD pattern, the barrier layer remained amorphous. Furthermore, the LiCoO₂ positive cathode exhibited a crystallite size of about 640 Å for the (003) grains while its refined lattice parameters (aₕₑₓ=2.8136(7)Å; cₕₑₓ=14.045(4)Å) match the theoretical values well that are given in the literature (ICDD 77-1370: aₕₑₓ=2.815(1)Å; cₕₑₓ=14.05(1)Å). This fact indicates that the crystalline LiCoO₂ positive cathode film may not react with any of its surrounding materials, including the substrate. The performance of the fully finished electrochemical apparatus is shown, for example, in FIG. 7.

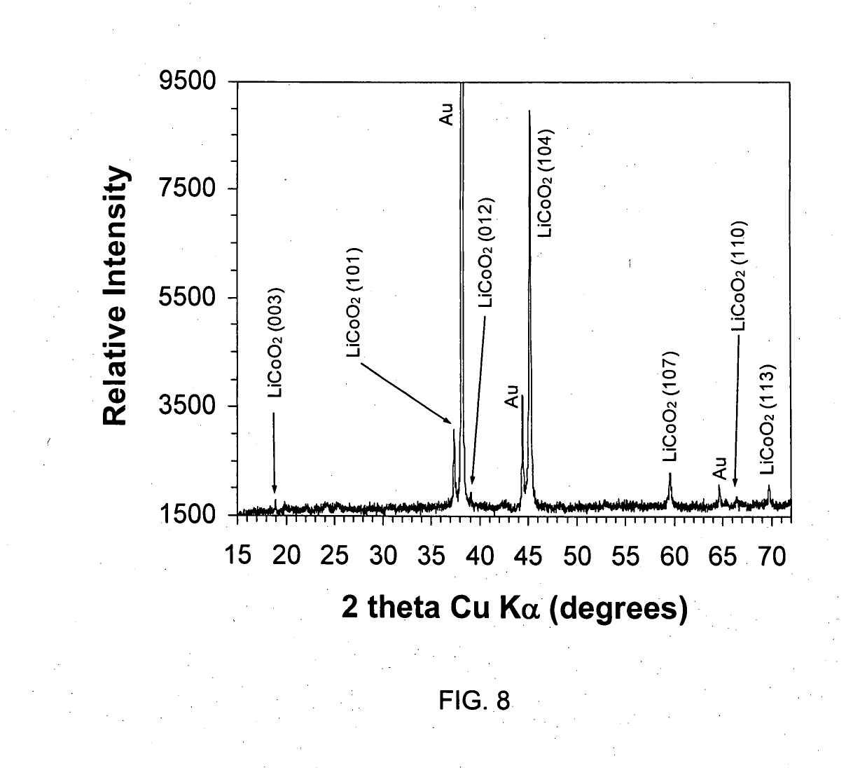

Also after fabricating a pure LiCoO₂ positive cathode over 3000 Å Au/300 Å Co/1000 Å SiO₂/5000 Å Si₃N₄/1000 Å SiO₂ onto 400 μm thick undoped silicon substrate followed by an anneal at 700° C. in air for 2 h a sufficiently crystalline LiCoO₂ positive cathode (aₕₑₓ=2.8140(5)Å; cₕₑₓ=14.065(7)Å; grain size for all grains in the range of 800-1000 Å) may be obtained with virtually theoretical lattice parameters (ICDD 77-1370: aₕₑₓ=2.815(1)Å; cₕₑₓ=14.05(1)Å) while the barrier layer may remain amorphous, indicating that the crystalline LiCoO₂ positive cathode film may not react with its surrounding materials, including the silicon substrate, as shown, for example, in FIG. 8.

3.1.2 The Negative Anode is Located Between the Barrier Layer and the Positive Cathode, which May be Equivalent to the Deposition and Potential Post-Deposition Anneal of the Negative Anode Prior to the Deposition of the Positive Cathode: “Inverted Configuration”.

Depending on the electrical properties of the barrier layer, an anode current collector may be fabricated prior to the deposition of the negative anode. That is, if the barrier layer, with or without sub-layers, is insulating in the area where the negative anode is to be fabricated, then an anode current collector may be deposited in order to create the necessary electrical access to the negative anode from the negative terminal. If, however, the barrier layer, with or without sub-layers, is electrically conductive in the area where the negative anode is to be deposited, then an additional inert metal layer (“conduction enhancer”) may be deposited between the barrier layer and the negative anode in order to enhance the current collecting properties of the barrier layer.

The negative anode, the anode current collector, and the conduction enhancer of the barrier layer may be deposited by selecting any of the many deposition methods including sputtering (RF-magnetron, DC-[pulse] magnetron, diode RF or DC, AC), electron beam evaporation, thermal (resistive) evaporation, plasma enhanced chemical vapor deposition, ion beam assisted deposition, cathodic arc deposition, electrochemical deposition, spray pyrolysis, etc.

The negative anode may be selected from the group of metal lithium, lithium-ion anodes, and so-called lithium-free anodes (See, e.g., Neudecker et al., U.S. Pat. No. 6,168,884 incorporated herein by reference). After the deposition of the negative anode, a post-deposition anneal may follow in order to improve the physical, chemical, and electrochemical properties of the negative anode. Preferably, such an anneal is applied to lithium-ion anodes, if at all, for example to Li₄Ti₅O₁₂, but not to metallic lithium and rarely to the group of lithium-free anodes.

The actual composition of the negative anode and the parameters of the applied post-deposition anneal may inform the selection of the barrier layer material. For example, for a metallic lithium anode a barrier layer of 5000 Å of Si₃N₄ on silicon substrate may provide the necessary barrier layer properties where the chemical inertness between the barrier layer and the metallic lithium may be accomplished through the positive* enthalpy of reaction (*criterion for no reaction) for the hypothetical reaction path 12Li+Si₃N₄=4Li₃N+3Si.

In an exemplary inverted configuration, the positive cathode may be deposited onto the electrolyte. Therefore, the temperatures permitted in a potential post-deposition anneal of the positive cathode may be limited, because, for example, a chemical reaction between the electrolyte and the positive cathode is preferably avoided as well as a reaction between the negative anode and the electrolyte.

3.2 Anode Configuration to be Used

Exemplary embodiments of “inverted configuration” have already been described above.

When fabricating an embodiment containing a negative anode entirely on top of the electrolyte, there may be no direct chemical interaction between the negative anode and the barrier layer.

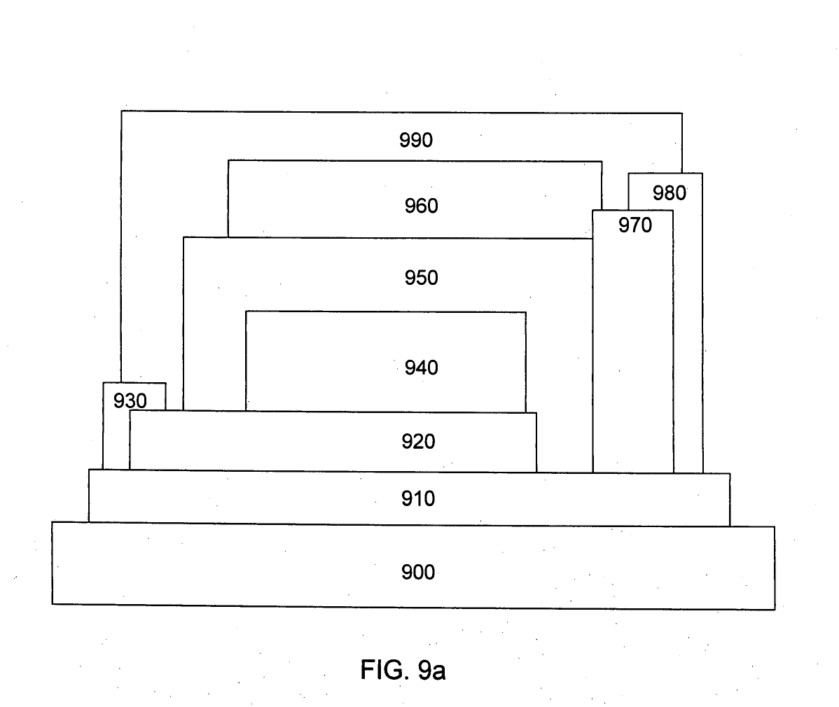

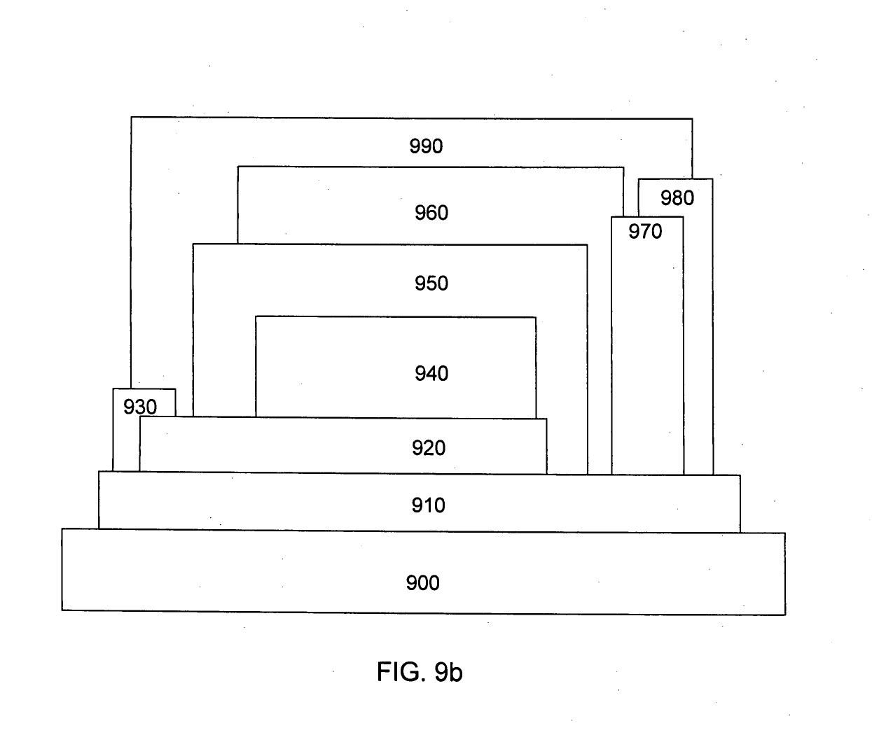

When fabricating an embodiment of a negative anode partially on top of the electrolyte, the “normal configuration” (See 3.1.1) is preferable. The overhanging area of the negative anode over the electrolyte layer edge may be prevented from touching the barrier layer for the case where there is an anode current collector present (See FIG. 9a). Without the presence of an adequately configured anode current collector the overhanging area of the negative anode may touch the barrier layer (See FIG. 9b). In either case, the negative anode should preferably be chemically inert to the barrier layer, because owing to its limited thickness and grain boundary morphology the anode current collector may not provide adequate chemical separation between the negative anode and the barrier layer. In such case the selection of the negative anode material determines the selection of the barrier layer material. As mentioned above, a pure CO₃O₄ barrier layer may not be used if the negative anode is a metallic lithium anode and this anode has contact to the Co₃O₄ barrier layer.

If the negative anode makes contact to the barrier layer, then two cases may need to be assessed: whether the negative anode makes contact to: 1) an insulating barrier layer area, or 2) an electrically conductive barrier layer area. In the first instance, it may be sufficient that this barrier layer area be chemically inert to the negative anode, such as Si₃N₄ when using a metallic lithium anode. For the second instance, a barrier sub-layer approach may, for example, be used for conductive substrates, for example, metallic ones and doped and undoped silicon. For insulating polymeric substrates, it is sufficient to use a non-continuous conductive barrier layer so that the positive part and the negative part of the battery are not short-circuited through this barrier layer.

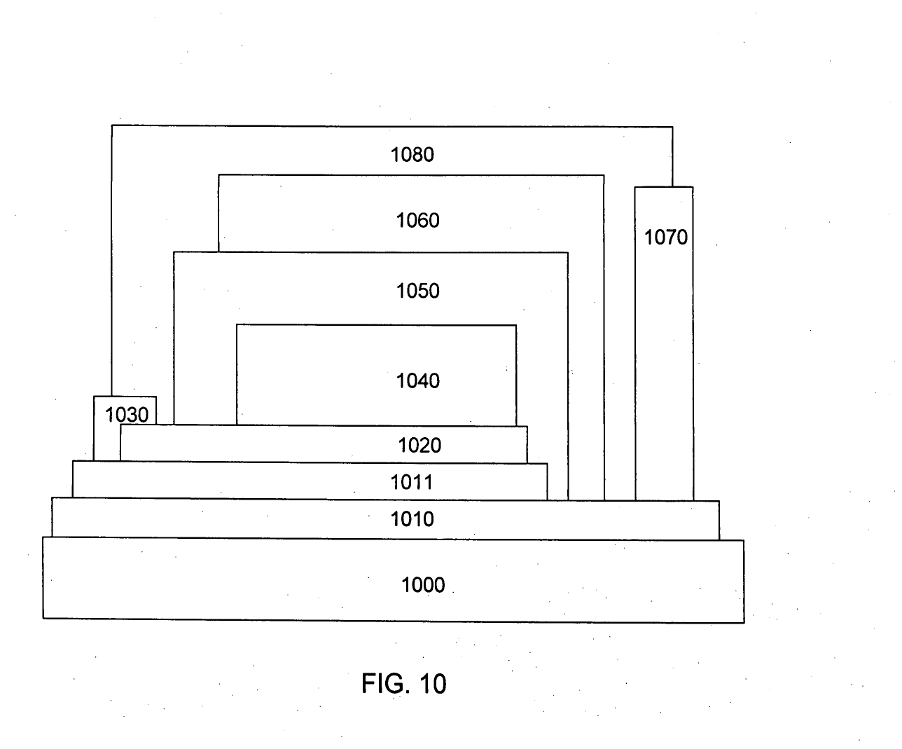

The use of, for example, a 1 micro-meter thick ZrN barrier sub-layer on Si substrate is relatively simple and effective for the embodiment where a metallic lithium negative anode makes contact to this ZrN barrier sub-layer, which in turn should not be shared with the positive part of the battery but instead the positive part of the battery may be located over an insulating barrier sub-layer such as Si₃N₄. One advantage of this latter example embodiment is that the ZrN barrier sub-layer also may serve as the anode current collector for the negative metallic lithium anode (See FIG. 10).

An anode current collector may comprise an inert metal, an inert alloy or an inert nitride and thus may not be prone to reacting with the barrier layer or the negative anode. The anode current collector should not make electrical contact to a conductive barrier layer or conductive individual barrier sub-layer to which also the positive cathode and/or the cathode current collector has electrical contact. Otherwise, the battery may be in a short-circuited state.

3.3 Type of Barrier Layer to be Used

This topic has been discussed, for example, in section 2. In addition, sections 3.1 and 3.2 discuss, for example, when the selection of the cathode and anode configurations determine the selection of the barrier layer material.

3.4 Substrate in Electrical Contact with Battery

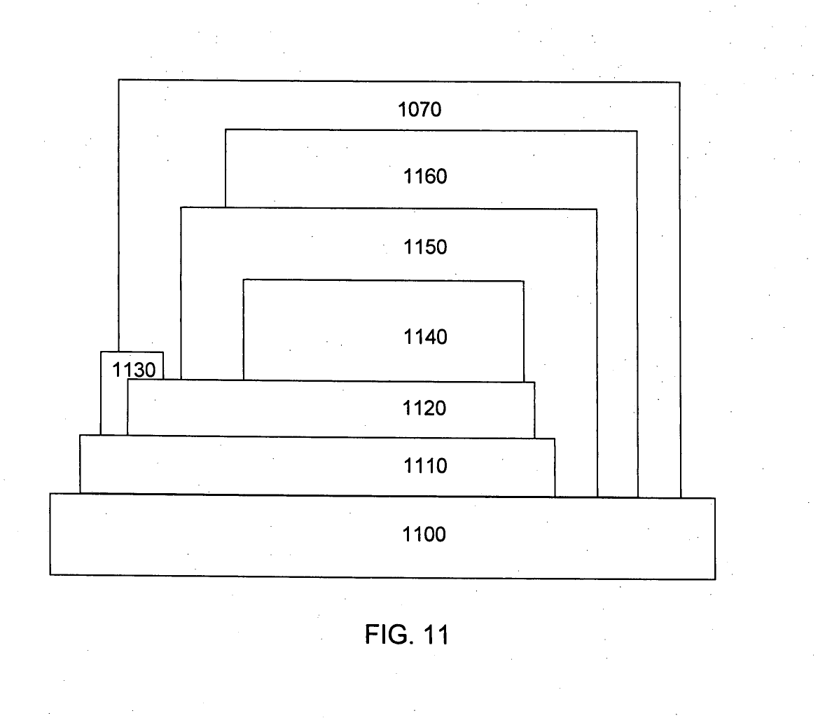

In an example embodiment where there is no reaction between the substrate and the positive cathode or the negative anode, the substrate with those electrodes may be brought into direct electrical contact or into indirect electrical contact via a current collector. However, for conductive substrates, such as metallic substrates, doped or undoped silicon wafers or metallized polymeric substrates, only one of those electrodes may, for example, be allowed to be in electrical contact with the substrate, because otherwise the battery may be shorted out or a strong battery leakage may be introduced. This exemplary approach has an advantage of conveniently using the conductive substrate as one of, for example, two terminals of an electrochemical apparatus (See FIG. 11).

3.5 Double Sided Battery

The present invention may include embodiments wherein an electrochemical apparatus is not limited to having only one battery on each side of the substrate. The fabrication, for example, of embodiments may include wherein each battery is deposited by a given battery component layer, such as the positive cathode, on both sides of the substrate using equipment that, for example, is capable of depositing both sides of the substrate at the same time prior to proceeding to the fabrication of the next battery component layer, which may also be deposited on both sides of the substrate at the same time.

The potential sequential fabrication process of the battery component layers may, for example, be done in the same manner as for a single sided battery. As a result of this exemplary approach of layer completion on both sides of the substrates prior to depositing the next layer on both sides of the substrate, a potential post-deposition anneal might not be applied to a layer on the other side of the substrate that should not be subjected to such a post-deposition anneal.

Another exemplary approach may be to partially complete the fabrication of the first battery on the first side of the substrate before proceeding to the partial completion of the fabrication of the second battery on the second side of the substrate. This approach may, for example, be employed when the available deposition equipment does not allow double sided depositions at the same time. For example, a deposit onto the first side of the substrate a cathode current collector and then a positive cathode layer may be accomplished before depositing a cathode current collector and a positive cathode layer onto the second side of the substrate. After these steps a post-deposition anneal may be applied to the partially completed batteries on this substrate at the same time prior to continuing the battery fabrication on the first side of the substrate using the fabrication sequence electrolyte-anode current collector-anode. Subsequently, the same fabrication sequence may be applied to the second side of the substrate before both sides are encapsulated with heat sensitive polymeric laminates on both sides of the substrates at the same time or thin-film encapsulations that may be applied at the same time or sequentially.

Depending on the actual conditions of a potential post-deposition anneal of the positive cathode and/or negative anode, a third approach may be possible where the fabrication of the first battery on the first side of the substrate may completed prior to starting the fabrication of the second battery on the second side of the substrate.

An example embodiment and implementation of the invention is described with reference to the drawings.

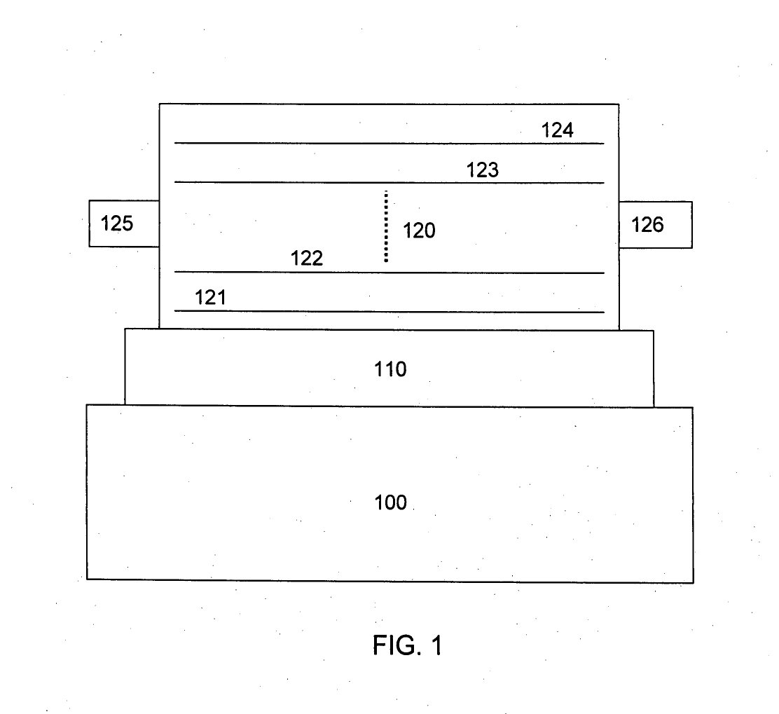

FIG. 1 illustrates one embodiment of the electrochemical apparatus. The substrate part (100) is chemically separated from the battery part (120) via a barrier layer (110). (121)-(124) are battery component layers. (125) is a positive battery terminal. (126) is a negative battery terminal.

FIG. 2a illustrates a schematic of a use of an electrically conductive barrier layer (210) on metallic substrate (200) where the electrical separation between the positive (200, 210, 220, 230, 240) and negative (260, 270, 280) part of the battery is accomplished through fabrication of the negative part entirely on top of the electrolyte (250). (290) is an encapsulation.

FIG. 2b illustrates a schematic of a use of an electrically conductive barrier layer (210) on metallic substrate (200) where the electrical separation between the positive (200, 210, 220, 230, 240) and the negative (260, 270, 280) part of the battery is accomplished through fabrication of the negative part entirely on top of the electrolyte (250). (290) is an encapsulation. The cathode current collector and the terminal have direct contact to the metallic substrate.

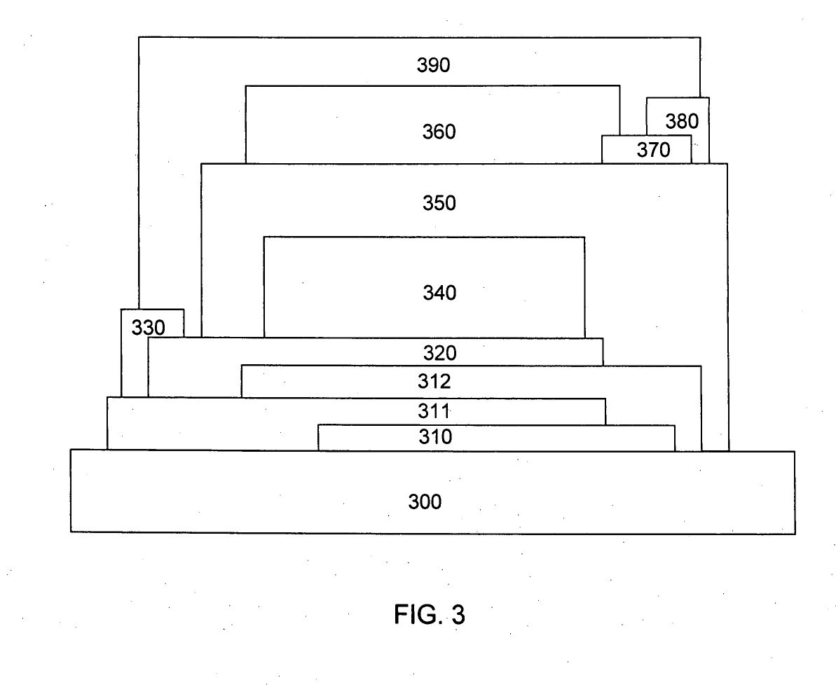

FIG. 3 illustrates a schematic of an example of an electrically conductive barrier layer consisting of individual sub-layers (310, 311, 312) where the electrical separation between the positive (320, 330, 340) and the negative (360, 370, 380) part of the battery is accomplished through fabrication of the negative part entirely on top of the electrolyte (350).

(300, 310, 311, 312) could all become part of the positive part of the battery depending on whether or not (311) and/or (312) are electrically conducting. The negative part may remain (360, 370, 380). If only (310) is electrically conducting, then (320, 330, 340) become part of the positive part of the battery. If only (311) is electrically conducting, then (300, 311, 330, 340, 350) become part of the positive part of the battery. If only (312) is electrically conducting, then (300, 312, 320, 330, 340) become part of the positive part of the battery. If (310) and (311) are electrically conducting, then (300, 310, 311, 320, 330, 340) become part of the positive part of the battery. If (311) and (312) are electrically conducting, then (300, 311, 312, 320, 330, 340) become part of the positive part of the battery. If (310) and (312) are electrically conducting, then (300, 310, 312, 320, 330, 340) become part of the positive part of the battery. Finally, if (310), (311), and (312) are electrically conducting, then (300, 310, 311, 312, 320, 330, 340) become part of the positive part of the battery. (300) is a metallic substrate, and (390) is an encapsulation. Barrier sub-layer (311) guarantees the chemical separation of the positive battery part from the substrate so as to prevent any chemical reactions between them during the post-deposition anneal of the positive cathode.

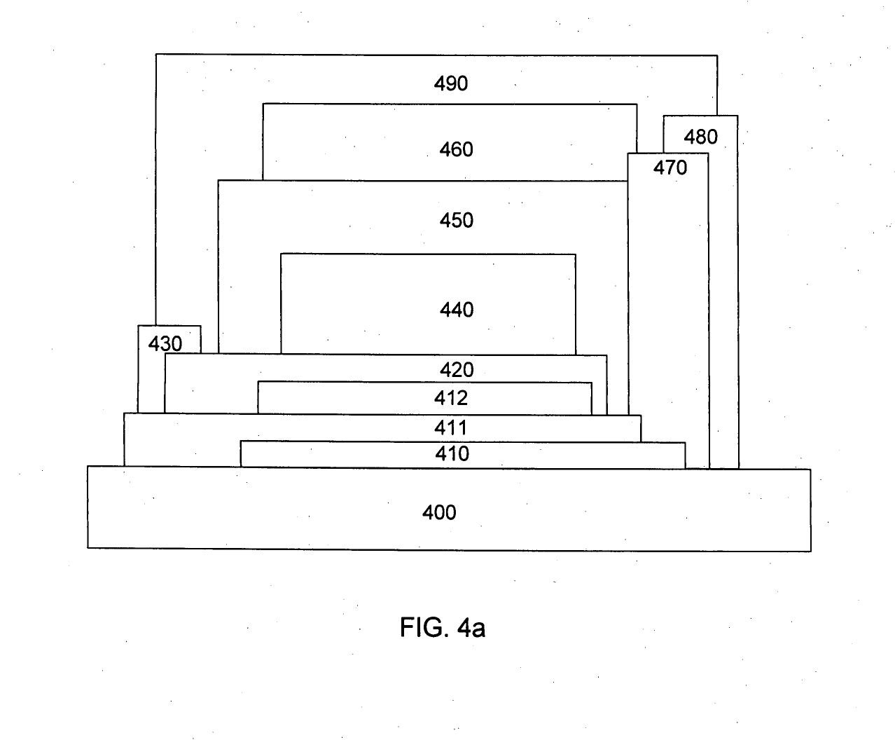

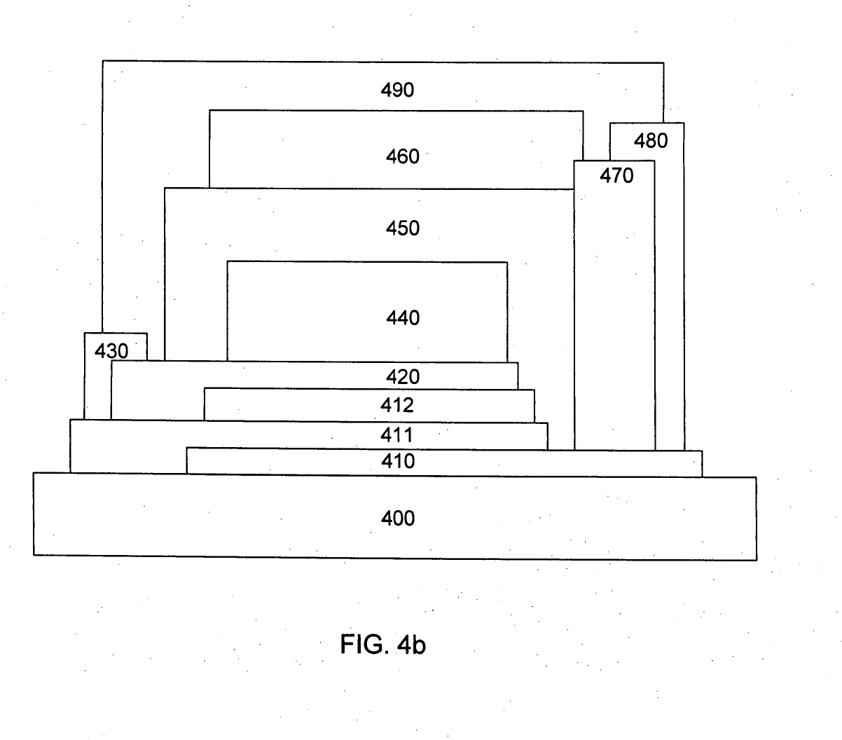

FIG. 4a illustrates a schematic of one example of an electrically conductive barrier layer consisting of individual sub-layers (410, 411, 412) where the electrical separation between the positive (420, 430, 440) and negative (400, 410, 460, 470, 480) part of the battery is not done via fabrication of the negative part entirely on top of the electrolyte (450). (412) could become part of the positive part of the battery if it is electrically conducting. (490) is an encapsulation. The electrical insulating barrier sub-layer (411) together with the electrolyte (450) separate electrically the positive battery part from the negative part, even if barrier sub-layer (412) is electrically conductive or insulating.

FIG. 4b illustrates a schematic of another example of an electrically conductive barrier layer consisting of individual sub-layers (410, 411, 412) where the electrical separation between the positive (420, 430, 440) and the negative (400, 410, 460, 470, 480) part of the battery is not done via fabrication of the negative part entirely on top of the electrolyte (450). (412) could become part of the positive part of the battery if it is electrically conducting. (490) is an encapsulation. The electrically insulating barrier sub-layer (411) together with the electrolyte (450) separate electrically the positive battery part from the negative part, even if the barrier sub-layer (412) is electrically conductive or insulating.

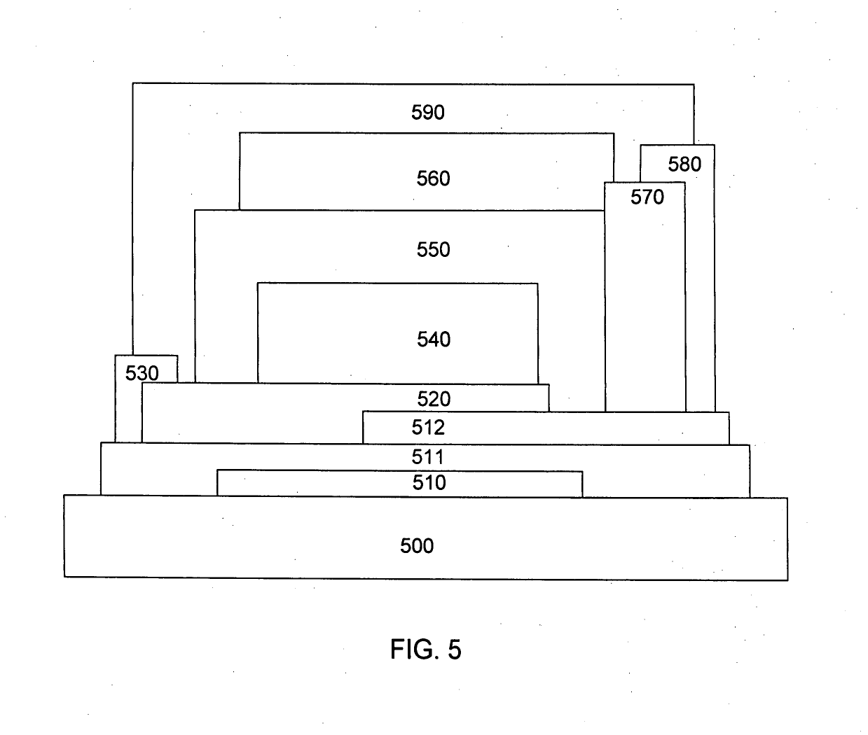

FIG. 5 illustrates a schematic of one example of an electrically conductive barrier layer consisting of individual sub-layers (510, 511, 512) where the electrical separation between the positive (500, 511, 520, 530, 540) and the negative (560, 570, 580) part of the battery is not done via fabrication of the negative part entirely on top of the electrolyte (550). (510) could become part of the positive part of the battery if it is electrically conducting. (590) is an encapsulation. The electrically insulating barrier sub-layer (512) together with the electrolyte (550) separate electrically the positive battery part from the negative part, even if barrier sub-layer (510) is electrically conductive or insulating, while the positive part and the negative part of the battery have the same conductive barrier sub-layer (511) underneath.

FIG. 6 illustrates a graph of an X-ray diffraction (XRD) pattern of a 1.6 μm thick LiCoO₂ positive cathode film fabricated onto 3000 Å gold cathode current collector over 300 Å cobalt adhesion layer over a gradiented, insulating barrier layer composed of 1000 Å SiO₂ /5000 Å Si₃N₄ /1000 Å SiO₂ on 50 micro-meter thick stainless steel foil type 430 substrate. The LiCoO₂ positive cathode was post-deposition annealed at 700° C. in air for 2 h, which affected the underlying substrate, the barrier layer, the cathode current collector adhesion layer, and the cathode current collector in the same thermal manner. As indicated by the absence of any related peaks in the XRD pattern, the barrier layer remained amorphous. Furthermore, the refined lattice parameters of the crystalline LiCoO₂ positive cathode film (aₕₑₓ=2.8136(7)Å; cₕₑₓ=14.045(4)Å) match the theoretical values given in the literature (ICDD 77-1370: aₕₑₓ=2.815(1)Å; cₕₑₓ=14.05(1)Å), which indicates that the crystalline LiCoO₂ positive cathode film did not react with any of its surrounding materials, including the substrate. Au: gold cathode current collector; Au+S: overlapping peaks of gold cathode current collector and stainless steel 430 substrate foil.

FIG. 7 illustrates a graph of an electrochemical cycle performance of an electrochemical apparatus. The electrochemical apparatus was operated at 25° C. between 4.2-3.8V at 1 mA for 10,000 consecutive charge-discharge cycles and showed virtually no capacity loss and virtually no overall resistance increase under these conditions. Charging was accomplished by a 7.5 min long step charge, that is, after discharge the electrochemical apparatus was connected to a 4.2V voltage source without any high or low current limitations.

FIG. 8 illustrates a graph of an X-ray diffraction (XRD) pattern of a 1.6 μm thick LiCoO₂ positive cathode film fabricated onto 3000 Å gold cathode current collector over 300 Å cobalt adhesion layer over a gradiented, insulating barrier layer composed of 1000 Å SiO₂/5000 Å Si₃N₄/1000 Å SiO₂ on 400 micro-meter thick undoped silicon substrate. The LiCoO₂ positive cathode was post-deposition annealed at 700° C. in air for 2 h, which affected the underlying substrate, the barrier layer, the cathode current collector adhesion layer, and the cathode current collector in the same thermal manner. As indicated by the absence of any related peaks in the XRD pattern, the barrier layer remained amorphous. Furthermore, the refined lattice parameters of the crystalline LiCoO₂ positive cathode film (aₕₑₓ=2.8140(5)Å; cₕₑₓ=14.065(7)Å) match the theoretical values given in the literature (ICDD 77-1370: aₕₑₓ=2.815(1)Å; cₕₑₓ=14.05(1)Å), which indicates that the crystalline LiCoO₂ positive cathode film did not react with any of its surrounding materials, including the silicon substrate. Au: gold cathode current collector. The peaks of the single crystal silicon substrate were eliminated by the theta-2theta geometry of the diffractometer.

FIG. 9a illustrates a schematic of an anode configuration of the “normal configuration” in which the negative anode is not in direct contact with the barrier layer.

FIG. 9b illustrates a schematic of an anode configuration of the “normal configuration” in which the negative anode is in direct contact with the barrier layer.

FIG. 10 illustrates a schematic of an anode configuration of the “normal configuration” in which the negative anode is in direct contact with an electrically conductive ZrN barrier sub-layer that also serves as the anode current collector.

FIG. 11 illustrates a schematic of a specific battery configuration in which the negative anode is in direct contact with the substrate in case the substrate is chemically inert to the negative anode. In such a case, the substrate may serve as the negative anode current collector and the negative terminal, if the substrate is sufficiently electrically conductive, as is the case for stainless steel, for example.

1-264. (canceled)

265. An electrochemical apparatus comprising a substrate further comprising a first side, a first electrochemically active cell on said first side, and a first barrier layer on said first side which chemically separates said first electrochemically active cell from said substrate, and wherein:
(a) said first barrier layer is not a pure oxide;
(b) said substrate is not selected from the group Zr and Ti;
(c) said substrate is not Al that is coated with metals or semi-metals selected from the group V, Mn, Mg, Fe, Ge, Cr, Ni, Zn, and Co;
(d) said first electrochemically active cell is not equipped with a LiₓV₂O_{y} cathode wherein 0<x≦100 and 0<y≦5;
(e) said first electrochemically active cell is not a solar battery;
(f) said barrier layer comprises an electrically insulating material; and
(g) said substrate is selected from the group consisting of metallic substrate, polymeric substrate, and doped or undoped silicon substrate.

266. The electrochemical apparatus of claim 265 wherein said barrier layer separates chemically said electrochemically active cell from said substrate by virtue of:
(a) its chemical inertness to said electrochemically active cell and said substrate; and
(b) its diffusion blocking properties relative to the electrons or the ions of any of the chemical elements of said electrochemically active cell and said substrate;
during the entire fabrication of said electrochemically active cell onto said substrate and during all operation and storage conditions of said electrochemical apparatus.

267. The electrochemical apparatus of claim 265 wherein:
(a) said barrier layer comprises an electrically conducting or electrically semi-conducting material;
(b) the electrical separation of the positive cathode and the negative anode is given either by the negative part of said electrochemically active cell not making contact to said barrier layer or the positive part of said electrochemically active cell not making contact to said barrier layer;
(c) said negative part of said electrochemically active cell comprises the negative anode, the anode current collector, and the negative terminal; and
(d) said positive part of said electrochemically active cell comprises the positive cathode, the cathode current collector, and the positive terminal.

268. The electrochemical apparatus of claim 265 wherein said barrier layer comprises a plurality of individual sub-layers that are selected from the group of electrically conducting, electrically insulating, and electrically semi-conducting materials and wherein the positive part of said electrochemically active cell is not in electrical contact with the negative part.

269. The electrochemical apparatus of claim 268 wherein said sub-layers exhibit all the same shape and area size.

270. The electrochemical apparatus of claim 268 wherein at least one of said sub-layers exhibits a different shape and area size than the other sub-layers.

271. The electrochemical apparatus of claim 265 wherein said barrier layer is adapted to cover said substrate only partially so that at least the positive part of said electrochemically active cell is separated from said substrate.

272. The electrochemical apparatus of claim 265 wherein said barrier layer is adapted to cover said substrate only partially so that at least the negative part of said electrochemically active cell is chemically separated from said substrate.

273. The electrochemical apparatus of claim 268 wherein said barrier layer and said individual sub-layers comprises a chemical compound selected from the group of metals, semi-metals, alloys, borides, carbides, diamond, diamond-like carbon, silicides, nitrides, phosphides, fluorides, chlorides, bromides, iodides, or from the group of any multinary compounds composed of borides, carbides, silicides, nitrides, phosphides, oxides, fluorides, chlorides, bromides, and iodides.

274. The electrochemical apparatus of claim 268 wherein said barrier layer and said individual sub-layers is selected from the group consisting of a single phase of crystalline, nano-crystalline, amorphous, or glassy material or any poly phase mixture or composite.

275. The electrochemical apparatus of claim 265 wherein said electrochemically active cell comprises a battery that operates based on lithium chemistry, thus comprising lithium metal batteries, lithium-ion batteries, and lithium free batteries.

276. The electrochemical apparatus of claim 265 wherein said electrochemically active cell comprises a positive thin-film cathode that is either deposited by a vacuum vapor deposition process or by a non-vacuum vapor deposition process and wherein the thickness of said positive thin-film cathode comprises less than 200 micro-meters.

277. The electrochemical apparatus of claim 276 wherein:
(a) said positive thin-film cathodes comprises single crystallites having a size of at least
(b) said electrochemically active cell further comprises a thin-film solid-state electrolyte having a thickness of less than 100 micro-meters;
(c) the thickness of said substrate is within the range of 0.1 micro-meters to 1 cm; and
(d) the thickness of said barrier layer ranges from 0.01 micro-meters to 1 mm.

278. The electrochemical apparatus of claim 265 wherein said electrochemically active cell comprises a thin-film negative anode selected from the group of lithium metal, lithium-ion anode, or a metal that does not form inter-metallic compounds with lithium and wherein the thickness of said thin-film negative anode is less than 200 micro-meters.

279. The electrochemical apparatus of claim 265 wherein said electrochemically active cell comprises a battery that operates based on lithium chemistry, thus comprising lithium metal batteries, lithium-ion batteries, and lithium-free batteries.

280. An electrochemical apparatus comprising a substrate with a first side, a first electrochemically active cell on said first side, and a first barrier layer on said first side which is adapted to chemically separate said first electrochemically active cell from said substrate; and with a second side, a second electrochemically active cell on said second side, and a second barrier layer on said second side which chemically separates said second electrochemically active cell from said substrate and wherein:
(a) said barrier layers on both substrate sides are not pure oxides;
(b) said substrate is not selected from the group Zr and Ti;
(c) said substrate does not comprise Al that is coated with metals or semi-metals selected from the group V, Mn, Mg, Fe, Ge, Cr, Ni, Zn, and Co;
(d) said electrochemically active cells on both substrate sides are not equipped with a LiₓV₂O_{y} cathode wherein 0<x≦100 and 0<y≦5;
(e) said electrochemically active cells on both substrate sides are not solar batteries; and
(f) said substrate is selected from the group consisting of metallic substrate, polymeric substrate, and doped or undoped silicon substrate.
and wherein said barrier layers on both sides of said substrate separate chemically said electrochemically active cells from said substrate by virtue of:
(g) the chemical inertness of said first barrier layer on said first side of said substrate relative to said first electrochemically active cell on said first side of said substrate and relative to said substrate;
(h) the chemical inertness of said second barrier layer on said second side of said substrate relative to said second electrochemically active cell on said second side of said substrate and relative to said substrate;
(i) the diffusion blocking properties of said first barrier layer on said first side of said substrate relative to the electrons or the ions of any of the chemical elements of said first electrochemically active cell on said first side of said substrate; and
(j) the diffusion blocking properties of said second barrier layer on said second side of said substrate relative to the electrons or the ions of any of the chemical elements of said second electrochemically active cell on said second side of said substrate during the entire fabrication of said first electrochemically active cell on said first side of said substrate and said second electrochemically active cell on said second side of said substrate and during all operation and storage conditions of said electrochemical apparatus.

281. The method of fabricating an electrochemical apparatus comprising the following step sequence:
(a) providing a substrate with a first and a second side wherein said substrate is selected from the group consisting of metallic substrate, polymeric substrate, and doped or undoped silicon substrate;
(b) depositing a first barrier layer on said first side;
(c) depositing a second barrier layer on said second side;
(d) fabricating a first electrochemically active cell on said first side on top of said first barrier layer, which in turn chemically separates said first electrochemically active cell from said substrate;
(e) fabricating a second electrochemically active cell on said second side on top of said second barrier layer, which in turn chemically separates said second electrochemically active cell from said substrate;
(f) wherein said first barrier layer and said second barrier layer are not selected to be a pure oxide;
(g) wherein said substrate is not selected from the group Zr and Ti;
(h) wherein said substrate is not selected to be Al that is coated with metals or semi-metals selected from the group V, Mn, Mg, Fe, Ge, Cr, Ni, Zn, and Co;
(i) wherein said first electrochemically active cell and said second electrochemically active cell are not equipped with a LiₓV₂O_{y} cathode wherein 0<x≦100 and 0<y≦5; and
(j) wherein said first electrochemically active cell and said second electrochemically active cell are not used as solar batteries.

282. The method of claim 281 wherein said steps of fabricating a first and/or a second electrochemically active cell comprises providing a positive cathode, and wherein said positive cathode of said first and/or second electrochemically cell is fabricated by an in-situ (during deposition) or ex-situ (post-deposition) temperature process between 100-1000° C. in order to accomplish that the positive cathode comprises crystallites having a size of at least 100 Å.
